(19) United States
(12) Patent Application Publication
(10) Pub. No.: US 2022/0005121 A1
(43) Pub. Date: Jan. 6, 2022

(54) MACHINE LEARNING SYSTEMS AND METHODS FOR ANALYZING EMERGING TRENDS

(71) Applicant: State Farm Mutual Automobile Insurance Company, Bloomington, IL (US)

(72) Inventor: Gregory L. Hayward, Bloomington, IL (US)

(21) Appl. No.: 16/293,273

(22) Filed: Mar. 5, 2019

Related U.S. Application Data
(60) Provisional application No. 62/746,325, filed on Oct. 16, 2018.
(60) Provisional application No. 62/745,067, filed on Oct. 12, 2018.
(60) Provisional application No. 62/674,366, filed on May 21, 2018.
(60) Provisional application No. 62/702,526, filed on Jul. 24, 2018.

(51) Int. Cl. G06Q 40/08; G06N 20/00

(52) U.S. Cl. CPC G06Q 40/08; G06N 20/00

(57) ABSTRACT

A system for detecting an emerging trend in insurance claims is provided. Each insurance claim may include a customer profile of a customer and claim data associated with the customer. The system is configured to (i) store a machine learning model; (ii) input a plurality of new insurance claims into the machine learning model; (iii) identify, by the machine learning model, the emerging trend in the new insurance claims; and (iv) generate a response corresponding to the emerging trend.

### RELATED APPLICATIONS

This application is related to U.S. Provisional Patent Application No. 62/746,325, filed Oct. 16, 2018, entitled “MACHINE LEARNING SYSTEMS AND METHODS FOR ANALYZING EMERGING TRENDS; U.S. Provisional Patent Application No. 62/745,067, filed Oct. 12, 2018, entitled “MACHINE LEARNING SYSTEMS AND METHODS FOR ELASTICITY ANALYSIS”; U.S. Provisional Patent Application No. 62/675,366, filed May 23, 2018, entitled “EMERGING TREND DETECTION FOR RISK MITIGATION & PREVENTION,” and U.S. Provisional Patent Application No. 62/702,526, filed Jul. 24, 2018, entitled “ELASTICITY MEASUREMENT FOR NEW BUSINESS ACQUISITION AND POLICY RENEWAL,” the entire contents and disclosure of which are hereby incorporated by reference herein in their entirety.

### FIELD OF INVENTION

This disclosure generally relates to detecting emerging trends in insurance claims and, more particularly, to a network-based system and method for detecting emerging trends in insurance claims, and machine learning model-based analysis of the insurance claims.

### BACKGROUND

Detection of trends in insurance claims has conventionally been a long, drawn out process performed by actuaries analyzing claim data over time. For instance, in the past, one trend in insurance claims that eventually became apparent was a spike in claims associated with drywall having mold issues. With conventional techniques, claim data from a large amount of claims submitted over time would need to be collected and reviewed before the trend is noticeable and identified and mitigating or preventive actions are taken. Some trends may not even be detected by these time- and labor-intensive techniques. Conventional techniques may have other drawbacks as well.

### BRIEF SUMMARY

The present disclosure generally relates to systems and methods for detecting emerging trends in insurance claims, such as in real-time or near real-time to allow for rapid responses to those trends. Insurance claims and noninsurance data, such as home data and vehicle data may be collected and analyzed by artificial intelligence or machine learning models to identify and then verify emerging trends in insurance claims. The machine learning model may be supervised or unsupervised, or a combination of both. The machine learning model may be trained by historical insurance claims. Reponses corresponding to the identified emerging trends may then be generated. The responses may include determining corrective actions that mitigate damage caused by the emerging trends, determining preventive actions that limit damage caused by the emerging trends in a future period of time, and/or adjusting an insurance policy based upon the emerging trends.

In one aspect, a computer system for detecting an emerging trend in insurance claims may be provided. The computer system may include at least one processor in communication with at least one memory device. Each insurance claim may comprise a customer profile of a customer and claim data associated with the customer. The at least one processor may be programmed to: (1) receive, from a database, a plurality of historical insurance claims; (2) store a machine learning model based upon the plurality of historical insurance claims; (3) input a plurality of new insurance claims into the machine learning model; (4) compare the plurality of new insurance claims with the machine learning model; (5) identify, by the machine learning model, the emerging trend in the new insurance claims; and/or (6) generate a response corresponding to the emerging trend. The computer system may have additional, less, or alternate functionality, including that discussed elsewhere herein.

In another aspect, a computer system for detecting an emerging trend in insurance claims may be provided. The computer system may include at least one processor in communication with at least one memory device. Each insurance claim may comprise a customer profile of a customer and claim data associated with the customer. The at least one processor may be programmed to (1) store a machine learning model; (2) input a plurality of new insurance claims into the machine learning model; (3) identify, by the machine learning model, the emerging trend in the new insurance claims; and/or (4) generate a response corresponding to the emerging trend. The computer system may have additional, less, or alternate functionality, including that discussed elsewhere herein.

In at least one further aspect, a computer-implemented method for detecting an emerging trend in insurance claims may be provided. Each insurance claim may comprise a customer profile of a customer and claim data associated with the customer. The method may be implemented on a trend detection server including at least one processor in communication with at least one memory device. The method may include: (1) storing a machine learning model; (2) inputting a plurality of new insurance claims into the machine learning model; (3) identifying, by the machine learning model, the emerging trend in the new insurance claims; and/or (4) generating a response corresponding to the emerging trend. The method may have additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the system and methods disclosed therein. It should be understood that each Figure depicts one embodiment of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and instrumentalities shown, wherein:

FIG. 1 depicts an exemplary computing environment in which techniques for training a neural network to identify an emerging trend in insurance claims, and/or trend associated with an customer or insurable asset, such as a vehicle or home, may be implemented, according to one embodiment;

FIG. 2 depicts an exemplary computing environment in which techniques for collecting and processing user input, and training a neural network to identify an emerging trend in insurance claims, and/or trend associated with an customer or insurable asset (e.g., a vehicle or a home) may be implemented, according to one embodiment;

FIG. 3 depicts an exemplary artificial neural network which may be trained by the neural network unit of FIG. 1 or the neural network training application of FIG. 2, according to one embodiment and scenario;

FIG. 4 depicts an exemplary neuron, which may be included in the artificial neural network of FIG. 3, according to one embodiment and scenario;

FIG. 5 depicts text-based content of an exemplary electronic insurance claim that may be processed by an artificial neural network, and depicts exemplary types of data fields for claim data associated with an auto insurance claim, in one embodiment;

FIG. 6 depicts exemplary fields for life and health insurance related data, which may be included in life and/or health related insurance claims, according to one embodiment;

FIG. 7 depicts exemplary fields of additional types of auto-related claim data and data fields, such as data gathered during an online application for auto insurance, according to one embodiment;

FIG. 8 depicts exemplary fields for life and health insurance related data, which may be included in life and/or health related insurance claims, according to one embodiment;

FIG. 9 depicts exemplary fields of additional types of auto-related claim data, such as exemplary damage repair codes for estimating the cost of repairing vehicle damage, according to one embodiment;

FIG. 10 depicts an exemplary computer-implemented method of detecting emerging trends in insurance claims, according to one embodiment;

FIG. 11 depicts another exemplary computer-implemented method of detecting emerging trends in insurance claims, according to one embodiment;

FIG. 12 depicts another exemplary computer-implemented method of detecting emerging trends in insurance claims, according to one embodiment;

FIG. 13 depicts another exemplary computer-implemented method of detecting emerging trends in insurance claims, according to one embodiment;

FIG. 14 depicts an exemplary configuration of a trend detection system;

FIG. 15 depicts an exemplary configuration of an exemplary user computing device; and

FIG. 16 depicts an exemplary configuration of an exemplary server computing device;

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The present embodiments are directed to employing, inter alia, machine learning techniques to discover emerging trends or trends in insurance claims. As used herein, an emerging trend includes a potential or actual trend, anomaly, or pattern in insurance claims, such as a continuous increase or decrease or a spike or dip in one or more data fields of insurance claims. Example data fields may be the number or frequency of insurance claims, or the dollar amount or severity of insurance claims, filed during a period of time.

As used herein, the term “claim,” “claim record,” “electronic claim record,” or “insurance claim” generally refers to a documents, records, or files that represent an insurance claim submitted by a policy holder of an insurance policy. Insurance claims may be auto, homeowners, renters, personal articles, life, and health insurance claims. An insurance claim may be in an electronic format or in a physical medium such as paper, film, microfilm, or video tape. An insurance claim is associated with a customer (also referred to as an insured, a claimant, or a policy holder) of an insurance policy. An insurance claim comprises a customer profile or user profile of the customer and claim data of the customer. As used herein, “claim data” of an insurance claim generally refers to data directly entered by the customer or insurance company, including, without limitation, free-form text notes, photographs, digital images, mobile device files, audio recordings, written records, receipts (e.g., hotel and rental car), and data from pre-Internet systems (e.g., paper files). Notes from claim adjusters and attorneys may also be included in claim data. Claim data may also include data entered by third parties, such as information from a repair shop, hospital, doctor, or police. As used herein, “customer profile” generally refers to data describing the customer and the insurance policy of the customer, such as the name, address, and date of birth of the customer and the type and terms of the insurance policy.

As used herein, the term “data” generally refers to information associated with a customer or insured or insurable asset, such as a vehicle or home. For example, data may include an electronic document representing a vehicle (e.g., automobile, truck, boat, and motorcycle) included in an insurance claim, demographic information about the vehicle operator, information collected by an autonomous vehicle, information related to the vehicle owned or operated by the vehicle operator, and/or information related to the home owned or rented by the customer.

Once an emerging trend is identified, a response corresponding to the emerging trend may be generated. A corrective action or a preventive action may be implemented to mitigate damage or limit future damage to the customer or the insurable assets. The identified emerging trends may relate to cause of loss or peril, reported claims, claim severity, claim frequency, line of business (e.g., auto, home, life, and health), geographical area (such as state or city), damage, loss, injury, repair cost, replacement cost, type of insured asset, and/or other conditions associated with an insurance claim. The trends may also relate to expenses, such as claim expenses, litigation expenses, acquisition expenses, salaries, and underwriting expenses, travel expense, and equipment expenses.

In some embodiments, supervised machine learning model is included. Data input to a machine learning model or a machine training model (or referred to as a machine learning module, algorithm, or program; an artificial intelligence model, module, algorithm, or program) may be harvested from historical insurance claims or historical claims. Input may include make, model, year, miles, technological features, and/or other characteristics of a vehicle, data collected by vehicle operation monitoring systems, the payout status of the claims, liability (e.g., types of injuries and location and types of treatment), disbursements related to the claim such as hotel costs and rental car costs, autonomous vehicle features and characteristics. Additional inputs to the machine learning model may include vehicle telematics data for automobiles, and for real property, home telematics data received from a smart home controller, such as information on how long and when the doors are unlocked, how often the security system is armed, and how long the vehicle is in operation during a period of time.

The present embodiments may detect new causes of loss. The new causes of loss may be used to set pricing of insurance. The present embodiments may dynamically characterize insurance claims, and/or dynamically determine causes of loss associated with insurance claims. The present embodiments may also dynamically update pricing models to better match insurance premium price to actual risk. For example, a machine learning model is used to discover emerging trends in auto insurance claims, and then adjust auto insurance policies based upon the emerging trends, such as adjusting the premium or coverage of the insurance policy.

The methods and systems described herein help risk-averse customers to lower their insurance premiums by identifying emerging trend in insurance claims. The methods and systems also allow new customers to receive more accurate pricing when they are shopping for insurance products. All of the benefits provided by the methods and systems described herein can be realized much more quickly than traditional approaches. The methods and systems disclosed herein reduce, in some cases dramatically, insurance company expenses and/or insurance customer premiums, due to increased efficiencies and improved predictive accuracies.

Exemplary Environment for Identifying Emerging Trends from Insurance Claims & Other Data

The embodiments described herein may relate to, inter alia, determining or identifying an emerging trend from a plurality of inputs, including insurance claims, using a machine training model. The machine training model may use artificial neural network (or neural network for short). More particularly, in some embodiments, one or more neural network models may be trained using historical insurance claims as training input.

The systems and methods may be implemented as an application, which may be provided to a client computing device (e.g., a smartphone, tablet, laptop, desktop computing device, or wearable device) of a user. A user of the application, who may be an employee of a company using the methods described herein or a customer of that company, may enter input into the application via a user interface.

The input may be transmitted from the client computing device to a remote computing device (e.g., one or more servers) via a computer network. The input is then processed further. For example, the input is entered into one or more trained neural network models to produce labels and weights indicating risk factors. The risk factors may be identified in electronic claim records, and/or may be predictive of certain real-world risks. Although historical insurance claims may be used in training one or more neural network models, insurance claims may be streamed in real-time or with near real-time latencies (e.g., on the order of 10 ms or less) along with other input to tune the machine learning model in a dynamic process. Optionally, the remote computing device may receive the input and determine, using a trained neural network, one or more risk indicators or risk levels applicable to the input. Risk indicators may be expressed numerically or as strings (e.g., as labels). Risk indicators may be expressed as Boolean values (e.g., risk/no risk), or scaled quantities (e.g., from 0.0-1.0). The determined risk indicators may be displayed to the user, and/or may be provided as input to another application (e.g., to an application which uses the risk indicators to calculate risk in a quotation calculation).

A quotation may include a price, parameters describing the vehicle, and/or one or more identified risk indicators. By transmitting input to a remote computing device for processing and analysis, an accurate risk indicator based upon a wealth of historical knowledge may be determined, and provided to the user in what may appear to the user to be a very rapid, even instantaneous, manner.

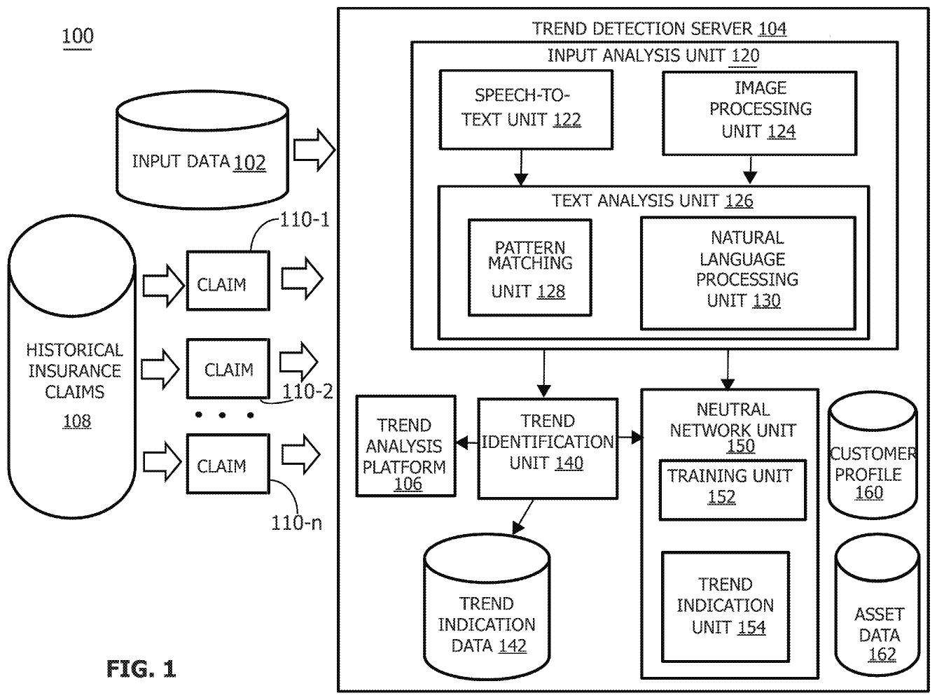

Turning to FIG. 1, an exemplary computing environment 100, representative of artificial intelligence platform or trend detection server for insurance, is depicted. Environment 100 includes a trend detection server 104. Environment 100 may further include input data 102 and historical insurance claims 108, both of which may comprise a list of parameters and a plurality (e.g., thousands or millions) of electronic documents. Input comprises new insurance claims. Input may further comprise noninsurance data.

Noninsurance data includes data collected from mobile devices, sensors, vehicles, or homes that are not collected for insurance purposes or not included in an insurance claim. Noninsurance data may include home data and vehicle data. Home data is data associated with one or more homes. Home data may be mobile device sensor data, vehicle-mounted or home-mounted sensor data, smart or intelligent home controller data, smart device or appliance data, and/or home telematics data. The home telematics data may include water or electricity usage data, home occupancy data, and/or other types of data about the home collected with the customer's permission. Vehicle data is data associated with one or more vehicles. Vehicle data may include mobile device sensor data, vehicle-mounted sensor data, vehicle operating or control data, autonomous or semi-autonomous vehicle data, and/or vehicle telematics data. The vehicle telematics data may include data associated with location, speed, route, acceleration, cornering, braking, images, sensors, and/or other types of information about the vehicle collected with the customer's permission.

Data included in the input 102 may be historical or current. Although data may be related to an ongoing claim filed by a customer, in some embodiments, data may comprise raw data parameters entered by a human user of the environment 100 or may be retrieved/received from another computing system. Data included in the input 102 may or may not relate to the claims filing process.

While some of the examples described herein refer to auto insurance claims, it should be appreciated that the techniques described herein are applicable to other types of data in other domains. For example, the techniques herein may be applicable to identify emerging trends in other insurance domains, such as agricultural insurance, homeowners insurance, health or life insurance, renters insurance, and personal articles insurance. In those cases, the scope and content of the data may differ, in addition to the domain-specific training and operational requirements applicable to the neural network(s).

As in another example, data in input and historical insurance claims may be collected from an existing customer filing a claim, or a potential or prospective customer applying for an insurance policy. The data may also be supplied by a third party, such as a company other than the proprietor of the environment 100. In some cases, the data may reside in paper files that are scanned or entered into a digital format by a human or by an automated process (e.g., via a scanner). Generally, data in input and historical insurance claims may comprise any digital information, from any source, created at any time.

Input data 102 and historical insurance claims 108 may both include claim data associated with auto, homeowners, renters, personal articles, life, health, and other types of insurance claims. Claim data comprises at least one data field. Claim data may be organized into at least one data fields. As used herein, classification field or data field is a field, classification, code, parameter, attribute, or characteristic of a portion of the claim data.

In the exemplary embodiment, Input data 102 is loaded into a trend detection server 104. The trend detection server 104 then organizes, analyzes, and processes the input data 102 and determines or identifies emerging trends. The loading of input data 102 may be performed by executing a computer program on a computing device that has access to the environment 100. The loading process may include the computer program coordinating the data transfer between input data 102 and the trend detection server 104 (e.g., by the computer program providing an instruction to trend detection server 104 as to the address or location at which input data 102 is stored). Trend detection server may reference this address to retrieve data from input data 102 to perform trend analysis and determination.

Trend detection server 104 comprises a collection of models configured to receive and process parameters and to produce labels, trend, risk and/or pricing information.

In the example embodiment, trend detection server 104 may be used to train multiple neural network models relating to different segments of, for auto insurance, vehicles or vehicle operators. For example, trend detection server 104 is used to train a neural network model to detect emerging trends in auto claims related to autonomous vehicles or individual autonomous or semi-autonomous feature or system. In another embodiment, trend detection server 104 may be used to train a neural network model for use in identifying an emerging trend in auto claims related to, or involving, motorcycles in a particular state or locality.

In the example embodiment, trend detection server 104 includes input analysis unit 120. The input analysis unit 120 analyzes and processes the input data 102. The input analysis unit 120 may also be used to analyze and process historical insurance claims 108. Input analysis unit 120 includes speech-to-text unit 122, and/or image analysis unit 124 which comprise, respectively, models for converting human speech into text and analyzing images (e.g., extracting information from hotel and rental receipts). In this way, data may comprise audio recordings (e.g., recordings made when a customer telephones a customer service center) that are converted to text and further used by trend detection server 104. In some embodiments, veracity information associated with the input is used by input analysis unit 120 to weight the data accordingly, and/or to train and operate neural network models.

In the example embodiment, input analysis unit 120 also includes text analysis unit 126, which includes pattern matching unit 128 and natural language processing (NLP) unit 130. In some embodiments, text analysis unit 126 determines facts regarding an insurance claim (e.g., the amount of money paid under a claim, repair/replacement cost, and code for cause of loss). Amounts may be determined in a currency- and inflation-neutral manner, so that claim loss amounts may be directly compared. In some embodiments, text analysis unit 126 analyzes text produced by speech-to-text unit 122 and/or image analysis unit 124.

In some embodiments, pattern matching unit 128 searches textual claim data loaded into trend detection server 104 for specific strings or keywords in text (e.g., “hit a deer,” “vehicle collision,” “faulty”) which are indicative of particular types of emerging trends. NLP unit 130 is used to identify, for example, entities or objects indicative of a trend (e.g., that an injury occurred to a person, that a single vehicle or multiple vehicle collision occurred, and that the person's leg or other body part was injured). NLP unit 130 identifies human speech patterns in data, including semantic information relating to entities, such as people, vehicles, homes, and other objects.

In some embodiments, relevant verbs and objects, as opposed to verbs and objects of lesser relevance are determined by the use of a machine learning model analyzing historical insurance claims. For example, a driver, type of vehicle, and a deer are relevant objects. Verbs indicating collision or injury are relevant verbs. In some embodiments, text analysis unit 126 comprises text processing algorithms (e.g., lexers and parsers) and outputs structured text in a format that is compatible with other units in the trend detection server 104.

In some embodiments, pattern matching unit 128 and natural language processing unit 130 act in conjunction to determine labels. For example, pattern matching unit 128 includes instructions to identify words indicating contact (e.g., “hit”, “crash”, or “collide”). Matched data are provided to natural language processing unit 130, which further processes the matched data to determine parts of speech such as verbs and objects, as well as relationships between the verbs and objects.

In the embodiment of FIG. 1, trend detection server 104 further includes a trend identification unit 140 to determine or identify emerging trends based upon analysis of insurance claims. Emerging trends are quantified or calculated with respect to individual data field in claim data, such as by assigning an anomaly or risk score between 0 and 1 to a given data field (e.g., make, model, autonomous feature, and deer). In other embodiments, trend identification unit 140 determines an indication of an emerging trend by generating labels which pertain to insurance claims as a whole, or in part. This labeling may be accomplished in various different ways, depending upon the embodiment.

In the example embodiment, trend identification unit 140 labels input data 102, or portions thereof, according to positive or negative pattern matching in the pattern matching unit 128. For example, if input data 102 matches the pattern “hit [a] deer,” wherein the article “a” is optional, then input data 102 is marked with labels such as (ACCIDENT, DEER) or (COLLISION, ANIMAL). Alternatively, in some embodiments, trend identification unit 140 labels input data 102, which comprises raw data or a claim filed by a customer, according to results obtained from natural language processing unit 130 (e.g., LIMB-INJURY). Trend identification unit 140 may label input data 102 according to Boolean values (e.g., PAID/NOT-PAID) or pre-determined ranges (e.g., claims having a payout of $0-$50,000; $50,000-$500,000; $500,000-$1,000,000; or >=$1,000,000).

In the example embodiment, labels are saved to and/or retrieved from a database, such as trend indication data 142. Claim labels may be generated from already-existing labels, and/or dynamically created labels (i.e., labels created at runtime) by trend identification unit 140. A set of labels may be associated with a set of input data 102, and the creation of new labels may be partially or entirely based upon existing labels and/or input data 102.

Dynamic creation of labels may, in some embodiments, are based upon user attributes and/or metadata, for example, a resident of the Eastern United States is assigned with a label related to weather such as a hurricane- or flood-related label or an attribute unique to the region. As used herein, metadata generally refers to data that pertains to an insurance claim, is derived from the insurance claim, describes the insurance claim, and/or is related to the insurance claim but is not part of the electronic record of the insurance claim.

In some embodiments, the output of natural language processing unit 130 may be provided to neural network unit 150 and used by training unit 152 to train a neural network model to label insurance types. For example, if natural language processing unit 130 indicates a collision with an inanimate object, such as a fence, pole, or otherwise, then the neural network may generate a label of COLLISION, indicating that the input data 102 may indicate a collision insurance policy. On the other hand, if natural language processing unit 130 indicates a collision with an animal, such as a deer, then the neural network may generate a label of COMPREHENSIVE.

It should be appreciated that in this example, the two labels (COLLISION and COMPREHENSIVE) are not mutually exclusive. That is, the neural network model may generate multiple labels corresponding to an indication by pattern matching unit 128 and/or natural language processing unit 130 that both types of insurance coverage are indicated. Further, additional processing, including by the use of an additional neural network model, maybe used to assign weight to a label. For example, a collision involving a deer may receive a higher weight than one involving a rabbit.

In the example embodiment, the labels in trend indication data 142 are fed to trend analysis platform 106, which performs a calculation using the labels and/or weights. For example, trend analysis platform 106 may sum the weights of a field or code within the claim data.

As noted, in some embodiments, trend identification unit 140 analyzes input data 102 (e.g., labeling claims) through the use of a neural network unit 150. Neural network unit 150 uses one or more neural networks. The neural network is any suitable type of neural network, including, without limitation, a recurrent neural network or feed-forward neural network. The neural network includes any number (e.g., thousands) of nodes or “neurons” arranged in multiple layers, with each neuron processing one or more inputs to generate a decision or other output.

In some embodiments, neural network models are chained together, so that the output from one model is fed into another model as input. For example, trend identification unit 140 may, in one embodiment, apply input data 102 to a first neural network model that is trained to generate labels. The output (e.g., labels) of this first neural network model is fed as input to a second neural network model which has been trained to predict or identify emerging trends based upon the presence of labels. In one embodiment, the second neural network is trained using noninsurance data to verify the emerging trend.

In the exemplary embodiment, neural network unit 150 includes training unit 152, and trend indication unit 154. To train the neural network to identify emerging trends, neural network unit 150 accesses historical insurance claims 108. Historical insurance claims are past insurance claims. They may be stored in a database. Historical insurance claims 108 comprises documents, images, and other types of data and comprises many (e.g., millions) of insurance claims which comprise data linking to a particular customer or to one or more vehicles, and which may further comprise, or be linked to, information pertaining to the customer and/or the insurable asset. Historical insurance claims 108 may be processed by input analysis unit 120. In particular, historical insurance claims 108 are analyzed by trend detection server 104 to generate claim records 110-1 through 110-n, where n is any positive integer. Each claim 110-1 through 110-n is processed by training unit 152 to train one or more neural networks to identify claim-related trends, such as claim frequency or severity.

In the example embodiment, neural network, from a trained model, identifies labels that correspond to specific data, metadata, and/or data field within input data 102. For example, neural network unit 150 is provided with instructions from input analysis unit 120 indicating that one or more particular types of insurance is associated with one or more portions of input data 102 (e.g., bodily injury, property damage, collision coverage, comprehensive coverage, liability insurance, med pay, or personal injury protection (PIP) insurance). In one embodiment, the one or more insurance types are identified by training the neural network 150 based upon types of peril, and/or cause of loss. For example, the neural network model is trained to determine that fire, theft, or vandalism indicates comprehensive insurance coverage.

In some other embodiments, input data 102 indicates a particular customer and/or vehicle. In that case, trend identification unit 140 may look up additional customer and/or vehicle information from customer profile 160 and asset data 162, respectively. Asset data includes data about the insured or insurable asset of the underlying insurance policy, collected with the customer's permission. Additional customer and vehicle information may include the age of the vehicle operator and/or vehicle type. The additional customer and/or asset information may be provided to neural network unit 150 and may be used to analyze and label input data 102 and, ultimately, may be used to determine or identify an emerging trend in the insurance claims.

In one embodiment, the training process is performed in parallel, and training unit 152 analyzes all or a subset of claims 110-1 through 110-n. Specifically, training unit 152 trains a neural network to identify one or more quantitative trends in claim records 110-1 through 110-n.

In some embodiments, claim records 110-1 through 110-n may be organized in a flat list structure, in a hierarchical tree structure, or any other suitable data structure. For example, the claim records are arranged in a tree wherein each branch of the tree is representative by line of business by state. Each of the claim records 110-1 through 110-n may represent a single claim, or may represent multiple claim records arranged in a group or tree.

Further, claim records 110-1 through 110-n may comprise links to claims, customers, vehicle, or other insurable assets (e.g., personal articles or homes) whose corresponding data is located elsewhere. In this way, one or more claims may be associated with one or more customers and one or more vehicles via one-to-many and/or many-to-one relationships. Claim data and/or noninsurance data may be data indicative of a particular risk or risks associated with a given claim, customer, and/or vehicle.

In one embodiment, insurance claims include claim metadata. Claim metadata may have been generated directly by a developer of the computing environment 100, for example, or may have been automatically generated as a direct product or byproduct of a process carried out in environment 100. For example, claim metadata may include a field indicating whether a claim was settled, amount of payouts, and the identity of corresponding payees.

Another example of claim metadata is the geographic location, such as the state in which a claim is submitted, which may be obtained via a global positioning system (GPS) sensor in a device used by the person or entity submitting the claim. Yet another example of claim metadata includes the category of the insurance claim (e.g., collision, liability, and uninsured or underinsured motorist). For example, a claim in historical insurance claims 108 is associated with a married couple, and includes the name, address, and other demographic information relating to the couple. Metadata of the claim may be associated with multiple vehicles owned or leased by the couple, and may contain information pertaining to those vehicles including without limitation, the vehicles' make, model, year, condition, mileage, or autonomous or semi-autonomous vehicle features.

In another embodiment, an insurance claim includes a plurality of claim data and claim metadata, including metadata indicating a relationship or linkage to other claims in historical insurance claims 108. In this way, neural network unit 150 may produce a neural network that has been trained to associate the presence of certain input parameters with one or more emerging trends.

Once the neural network has been trained, trend indication unit 154 may apply the trained neural network to input data 102 as processed by input analysis unit 120. In one embodiment, input analysis unit 120 merely “passes through” input data 102 without modification. The output of the neural network, indicating risks, such as labels pertaining to the entirety of, or portions of input data 102, is then provided to trend identification unit 140. Trend identification unit 140 inserts the output of the neural network (e.g., labels) into an electronic database, such as trend indication data 142. Alternatively, or additionally, trend indication unit 154 may use label information output by the neural network to determine attributes of input data 102, and may provide those attributes to trend identification unit 140.

In some embodiments, each label or attribute is associated with a confidence score and/or weight. Confidence scores may be assigned based upon the source of the information (e.g., if the information is from asset data 274, then a score of 1.0 is assigned; whereas, if the information is inferred and/or provided by a user, a lower confidence score is assigned). Trend identification unit 140 then forwards the labels and/or scores to trend analysis platform 106.

Trend detection server 104 may further include customer profile 160 and asset data 162, used by trend identification unit 140 to provide input parameters to neural network unit 150. Customer profile 160 may be an integral part of trend detection server 104, or may be located separately from the trend detection server 104. In some embodiments, customer profile 160 or asset data 162 are provided to trend detection server 104 via separate means (e.g., via an API call), and may be accessed by other units or components of environment 100. Customer profile 160 and asset data 162 may be provided by a third-party service.

Customer profile 160 may include mobile device data, vehicle or home telematics data, smart or autonomous vehicle feature data, intelligent home data, vehicle-mounted sensor or system data, home-mounted sensor or system data, other sensor data, or other data generated by the customer computing devices and shared with their permission or affirmative consent.

Asset data 162 may comprise a database comprising information describing vehicle makes and models, including information about model years and model types (e.g., model edition information, engine type, or any upgrade packages). Asset data 162 may indicate whether certain make and model year vehicles are equipped with safety features (e.g., lane departure warnings). The asset data 162 may also relate to autonomous or semi-autonomous vehicle features or technologies of the vehicle, and/or sensors, software, and electronic components that direct the autonomous or semi-autonomous vehicle features or technologies.

In the case of homes, asset data 162 includes features of home, such as roofing, flooring, tiling, siding, number of floors, floor plan, square footage, and size of yard, and whether such home is equipped with one or more smart home features, including smart sprinkler systems or smart security systems. Both customer profile 160 and asset data 162 may be used to train a neural network model.

### Exemplary Training Model System

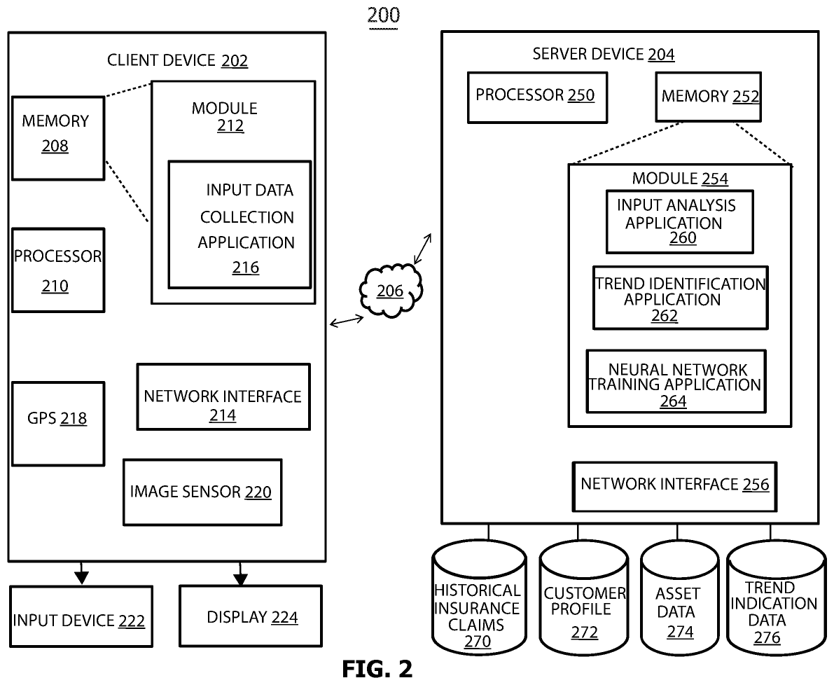

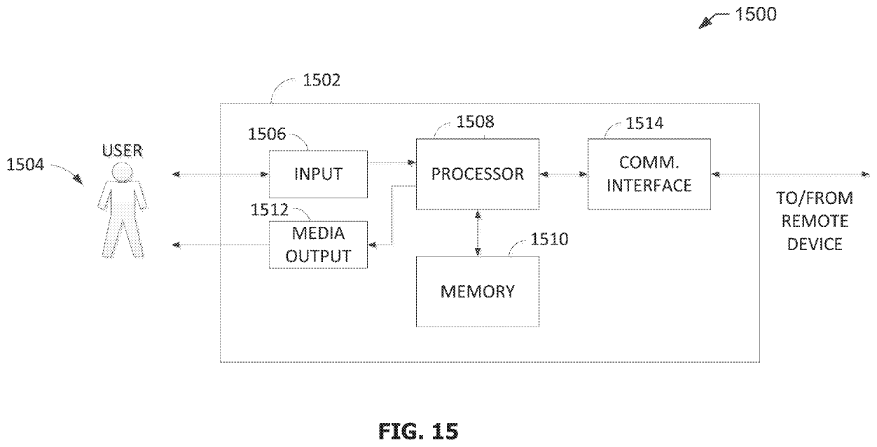

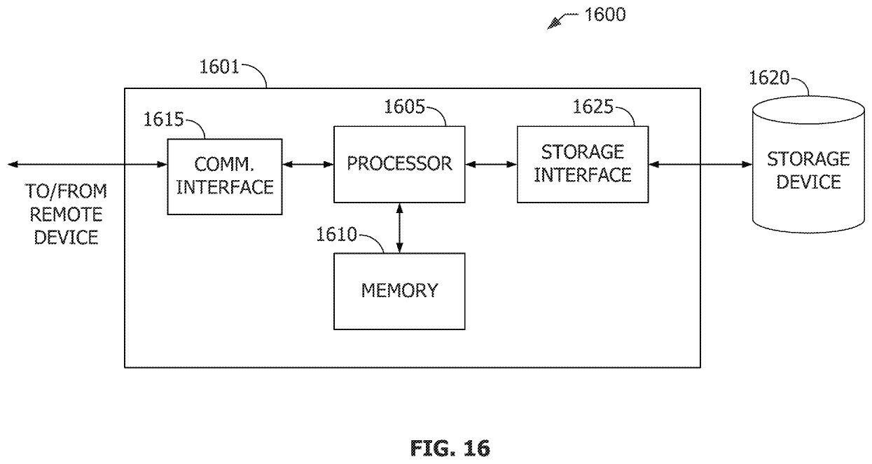

With reference to FIG. 2, a high-level block diagram of an emerging trend training model system 200 is illustrated, which implements communications between a client device 202 and a server device 204 via network 206 to provide emerging trend identification, classification, and/or analysis. FIG. 2 corresponds to one embodiment of computing environment 100 of FIG. 1, and also includes various user/client-side components. For simplicity, client device 202 is referred to herein as client 202, and server device 204 is referred to herein as server 204. Client device 202 may be similar to user computing device 1502 shown in FIG. 15. Server device 204 may be similar to server computing device 1601 shown in FIG. 16. Server 204 may host services relating to neural network training and operation, and may be communicatively coupled to client 202 via network 206. Server 204 includes a trend detection server 104.

Although only one client device is depicted in FIG. 2, it should be understood that any number of client devices 202 are supported. Client device 202 includes a memory 208 and a processor 210 for storing and executing, respectively, a module 212. While referred to as singular, processor 210 may include any suitable number of processors of one or more types (e.g., one or more CPUs, graphics processing units (GPUs), and cores). Similarly, memory 208 may include one or more permanent memories (e.g., a hard drive and/or solid state memory).

In the example embodiment, module 212, stored in memory 208 as a set of computer-readable instructions, comprises an input data collection application 216 which, when executed by the processor 210, causes input data to be stored in memory 208. The data stored in memory 208 comprises, for example, raw data retrieved from input data 102. Input data collection application 216 may be implemented as web page (e.g., HTML, JavaScript, and CSS) and/or as a mobile application for use on a standard mobile computing platform.

Input data collection application 216 may store information in memory 208, including the instructions required for its execution. The input data collected by input data collection application 216 may be transmitted to server device 204 by network interface 214 via network 206, where the input data is processed as described above to determine an emerging trend in insurance claims. In one embodiment, input data collection application 216 comprises data or insurance claims used to train a model (e.g., scanned insurance claims).

In the example embodiment, client device 202 also includes GPS sensor 218, an image sensor 220, input device 222 (e.g., a keyboard, mouse, touchpad, and/or other input peripheral device), and display 224 (e.g., an LED screen). Input device 222 may include components that are integral to client device 202, and/or exterior components that are communicatively coupled to client device 202, to enable client device 202 to accept inputs from the user. Display 224 may be either integral or external to client device 202, and may employ any suitable display technology. In some embodiments, input device 222 and display 224 are integrated, such as in a touchscreen display. Execution of the module 212 may further cause the processor 210 to associate device data collected from client 202 and/or sensor data with insured or insurable asset data (e.g., vehicle or home-related data) and/or customer profile.

In some embodiments, client 202 may receive data from trend indication data 142 and trend analysis platform 106. Such data, indicating emerging trends, labels and/or a trend computation, may be presented to a user of client 202 by a display 224.

In the example embodiment, execution of the module 212 further causes the processor 210 of the client 202 to communicate with the processor 250 of the server 204 via network interface 214 and network 206. As an example, an application related to module 212, such as input data collection application 216, when executed by processor 210, causes a user interface to be displayed to a user of client device 202 via display 224. The application may include graphical user input (GUI) components for acquiring data (e.g., photographs) from image sensor 220, GPS coordinate data from GPS sensor 218, and textual user input from input device(s) 222.

In the example embodiment, the processor 210 of the client 202 transmits the aforementioned acquired data to server 204, and processor 250 of the server 204 passes the acquired data to a neural network, which accepts the acquired data and perform a computation (e.g., training of the model, or application of the acquired data to a trained neural network model to obtain a result). With specific reference to FIG. 1, insurance claims and noninsurance data acquired by client 202 may be transmitted via network 206 to a server implementing trend detection server 104, and may be processed by input analysis unit 120 before being applied to a trained neural network by trend identification unit 140.

As described with respect to FIG. 1, the processing of input from client 202 may include associating customer profile 160 and asset data 162 with the acquired insurance claims. The output of the neural network may be transmitted, by a trend identification unit 140 in trend detection server 104, back to client 202 for display (e.g., in display 224) and/or for further processing.

Network interface 214 may be configured to facilitate communications between client 202 and server 204 via any hardwired or wireless communication network, including network 206 which may be a single communication network, or may include multiple communication networks of one or more types (e.g., one or more wired and/or wireless local area networks (LANs), and/or one or more wired and/or wireless wide area networks (WANs) such as the Internet). Client 202 may cause insurance trend related data to be stored in memory 252 of server 204 and/or a remote database such as customer profile 160.

In the example embodiment, server 204 includes a processor 250 and a memory 252 for executing and storing, respectively, a module 254. Module 254, stored in memory 252 as a set of computer-readable instructions, facilitates applications related to processing and/or collecting insurance trend related data, including claim data and claim metadata, and insurance policy application data. For example, module 254 includes input analysis application 260, trend identification application 262, and neural network training application 264.

Input analysis application 260 may correspond to input analysis unit 120 of environment 100 of FIG. 1. Trend indication application 262 may correspond to trend identification unit 140 of environment of FIG. 1, and neural network training application 264 may correspond to neural network unit 150 of computing environment 100 of FIG. 1. Module 254 and the applications contained therein may include instructions which, when executed by processor 250, cause server 204 to receive and/or retrieve input data from (e.g., raw data and/or an electronic claim) from client device 202. In one embodiment, input analysis application 260 processes the data from client 202, such as by matching patterns, converting raw text to structured text via natural language processing, by extracting content from images, or by converting speech to text.

In the example embodiment, throughout the aforementioned processing, processor 250 reads data from, and writes data to, a location of memory 252 and/or to one or more databases associated with server 204. For example, instructions included in module 254 causes processor 250 to read data from historical insurance claims 270, which are communicatively coupled to server device 204, either directly or via communication network 206. Historical insurance claims 270 correspond to historical insurance claims 108, and processor 250 contains instructions specifying analysis of a series of electronic claim documents of historical insurance claims 270, as described above with respect to claims 110-1 through 110-n of historical insurance claims 108 in FIG. 1.

In some embodiments, processor 250 queries customer profile 272 and insured or insurable asset data 274 for data related to electronic insurance claims and raw data, as described with respect to FIG. 1. In one embodiment, customer profile 272 and asset data 274 correspond, respectively, to customer profile 160 and asset data 162. In another embodiment, customer profile 272 and/or asset data 274 are integral to server 204. Module 254 may also facilitate communication between client 202 and server 204 via network interface 256 and network 206, in addition to other instructions and functions.

Although only a single server 204 is depicted in FIG. 2, it should be appreciated that it may be advantageous in some embodiments to provision multiple servers for the deployment and functioning of the emerging trend training model system 200. For example, the pattern matching unit 128 and natural language processing unit 130 of input analysis unit 120 may need CPU-intensive processing. Therefore, deploying additional hardware provides additional execution speed. Historical insurance claims 270, customer profile 272, asset data 274, and trend indication data 276 may be geographically distributed.

While the databases depicted in FIG. 2 are shown as being communicatively coupled to server 204, it should be understood that historical insurance claims 270, for example, may be located in a database of separate remote servers or any other suitable computing devices communicatively coupled to server 204. Distributed database techniques (e.g., sharing and/or partitioning) may be used to distribute data. In one embodiment, a free or open source software framework such as Apache Hadoop® is used to distribute data and run applications (e.g., trend indication application 262). It should also be appreciated that different security needs, including those mandated by laws and government regulations, may in some cases affect the embodiment chosen, and configuration of services and components.

In the exemplary embodiment, in a manner similar to that discussed above in connection with FIG. 1, historical insurance claims 270 are processed by server 204 and used by neural network training application 264 to train an artificial neural network. Then, when module 254 processes input from client 202, the data output by the neural network(s) (e.g., data indicating labels, risks, or weights) are passed to trend indication application 262 for computation, quantification, or identification of one or more emerging trends, or trend levels, in insurance claims, which may be expressed in alpha-numeric, Boolean, decimal, or any other suitable format. The calculated emerging trends are then transmitted to client device 202 and/or another device. The calculated emerging trend may be used for further processing by client device 202, server device 204, or another device.

It should be appreciated that the client/server configuration depicted and described with respect to FIG. 2 is but one possible embodiment. In some cases, a client device such as client 202 is not used. In that case, input data is entered, by computer programs, or manually, directly into server 204.

The embodiment varies according to the purpose for which the trend detection server is being utilized. For example, a different hardware configuration may be preferable if the trend detection server is being used to provide a risk analysis to an end user or customer, whereas another embodiment may be preferable if the trend detection server is being used to provide risk as part of a backend service. Furthermore, in some embodiments, the trained neural network are packaged and distributed to a client 202 (i.e., the trained neural network is operated on the client 202 without the use of a server 204).

In some embodiments, in operation, the user of client device 202, by operating input device 222 and viewing display 224, opens input data collection application 216 to enter personal information. The user may be an employee of a company controlling trend detection server 104, or a customer or end user of the company. Input data collection application 216 may then walk the user through the steps of submitting a claim.

In some embodiments, before the user can fully access input data collection application 216, the user is asked to authenticate (e.g., enter a valid username and password). Afterwards, the user is then allowed to utilize input data collection application 216. Module 212 comprises instructions that identify the user and cause input data collection application 216 to present a particular set of questions or prompts for input to the user, based upon information that input data collection application 216 collects, including without limitation information about the user or any insurable or insured asset.

In some embodiments, module 212 further identifies a subset of historical insurance claims 270 or noninsurance data to be used in training a neural network, and/or may indicate to server device 204 that the use of a particular neural network model or particular neural network models is appropriate. For example, if the user is applying for auto insurance on a car of a particular make, model, and year, then module 212 transmits the user's name and personal information, the location of the user as provided by GPS 218, a photograph of the vehicle to be insured captured by image sensor 220, and the make, model, and year of the vehicle to server device 204.

In some embodiments, location data from client device 202 are used by a neural network to label risk. As noted above, location may be provided to one or more neural networks in the trend detection server to generate labels and determine risk. For example, the zip code of a vehicle operator, whether provided via GPS or entered manually by a user, causes the neural network to generate a label applicable to the vehicle operator such as RURAL, SUBURBAN, or URBAN.

In the example embodiment, the labels are used in analysis of emerging trends, and are weighted accordingly. For example, the neural network assigns a higher risk weight to the RURAL label, due to an emerging trend indicating an increased likelihood of collision with animals for rural vehicles.

In the exemplary embodiment, another label is associated with emerging trends, such as an increase in collision for vehicles undergoing long trips. A LONG-TRIP label is generated to reflect that the vehicle operator drives longer trips than other drivers on average, and may be associated with vehicle operators who the neural network labels as RURAL.

In some embodiments, labels are generated based upon seasonal information, in whole or in part. The neural network generates labels and/or adjusts label weights that are based upon both the location provided in input data and the seasonal information. For example, the trained neural network model identifies emerging trends associated with drivers who drive in the city in the summer as having a higher risk.

By the time the user of client 202 submits an application for vehicle insurance or files a claim, server 204 may have already processed the electronic claim records in historical insurance claims 270 and noninsurance data and trained a neural network model to analyze the information provided by the user to output any emerging trends associated with above-average risk indications, labels, and/or weights.

In the example embodiment, the information collected is associated with a claim identification number so that the information can be referenced as a whole. Server 204 processes the information as it arrives, or processes the information collected by input data collection application 216 and audio recordings at different times. Once information sufficient to process the claim has been collected, server 204 passes all of the processed information (e.g., from input analysis application) to trend identification application 262, which may input the information to the trained neural network model.

In the example embodiment, while the processing of the claim or application is pending, client device 202 displays an indication that the processing of the claim is ongoing and/or incomplete. When the claim is ultimately processed by server 204, an indication of completeness is transmitted to client 202 and displayed to user, for example via display 224. Missing information may cause the model to abort with an error.

In some embodiments, the labels of input data (insurance claims and noninsurance data) performed by the systems and methods described herein are dynamically updated. Specifically, a model that has been trained on a set of electronic claim records from historical insurance claims 270 is updated dynamically using historical insurance claims or new insurance claims, such that the model is updated on a much shorter timeframe. For example, the model is adjusted weekly or monthly to take into account newly-settled claims. As used herein, new insurance claims are newly-settled claims, and historical insurance claims are settled claims in the past.

In one embodiment, the settlement of a claim triggers an immediate update of one or more neural network models included in the trend detection server. For example, the settlement of a claim involving personal injury that occurs on a boat triggers updates to a set of personal injury neural network models pertaining to boat insurance. In addition, or alternatively, as new claims are filed and processed, new labels may be dynamically generated, based upon risks identified during the training process. In some embodiments, a human reviewer or team of reviewers are responsible for approving the generated labels and their associated weights before they are used.

While FIG. 2 depicts a particular embodiment, the various components of environment 100 may interoperate in a manner that is different from that described above, and/or the environment 100 may include additional components not shown in FIG. 2. For example, an additional server/platform may act as an interface between client device 202 and server device 204, and may perform various operations associated with providing the labeling and/or trend analysis operations of server 204 to client device 202 and/or other servers.

### Exemplary Artificial Neural Network

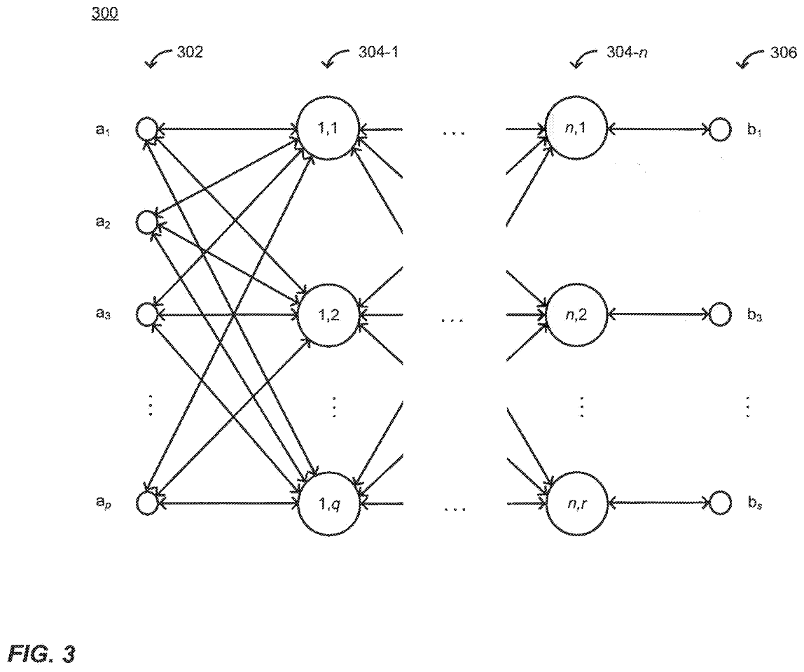

FIG. 3 depicts an exemplary artificial neural network 300 which is trained by neural network unit 150 of FIG. 1 or neural network training application 264 of FIG. 2, according to one embodiment and scenario. The example neural network 300 includes layers of neurons 302, 304-1 to 304-n, and 306, including input layer 302, one or more hidden layers 304-1 through 304-n, and output layer 306. Each layer may include any number of neurons, i.e., q, r, and n in FIG. 3 may be any positive integers. It should be understood that neural networks of a different structure and configuration from those depicted in FIG. 3 may be used to achieve the methods and systems described herein.

In the example embodiment, input layer 302 may receive different input data. Using auto insurance as an example, input layer 302 includes a first input a₁ which represents an insurance type (e.g., collision), a second input a₂ representing patterns identified in input data, a third input a₃ representing a vehicle make, a fourth input a₄ representing a vehicle model, a fifth input a₅ representing whether a claim was paid, a sixth input a₆ representing an inflation-adjusted dollar amount disbursed under a claim, and so on. Input layer 302 may comprise thousands or more inputs. In some embodiments, the number of elements used by neural network 300 changes during the training process, and some neurons are bypassed or ignored if, for example, during execution of the neural network, they are determined to be of less relevance.

In the example embodiment, each neuron in hidden layer(s) 304-1 through 304-n processes one or more inputs from input layer 302, and/or one or more outputs from neurons in one of the previous hidden layers, to generate a decision or output. Output layer 306 includes one or more outputs each indicating a label, confidence factor, and/or weight describing the inputs. The confidence factor and/or weight are reflective of how strongly claim data indicates an emerging trend. For instance, 0.5 indicates an emerging trend of potential likelihood, while 1.0 indicates an emerging trend of strong likelihood, and 2.0 indicates an emerging trend of high likelihood.

A label may indicate the presence (ACCIDENT, DEER) or absence (DROUGHT) of an emerging trend. In some embodiments, however, outputs of neural network 300 are obtained from a hidden layer 304-1 through 304-n in addition to, or in place of, output(s) from output layer(s) 306.

In some embodiments, each layer has a discrete, recognizable, function with respect to input data. For example, if n=3, a first layer analyzes the first dimension of the inputs, a second layer the second dimension, and the final layer the third dimension of the inputs. Dimensions may correspond to aspects of a vehicle operator considered strongly determinative, then those considered of intermediate importance, and finally those of less relevance.

In other embodiments, the layers are not clearly delineated in terms of the functionality they perform. For example, two or more of hidden layers 304-1 through 304-n may share decisions relating to labeling, with no single layer making an independent decision as to labeling.

In some embodiments, neural network 300 comprises a recurrent neural network, where the calculation performed at each neuron is dependent upon a previous calculation. It should be appreciated that recurrent neural networks may be more useful in performing certain tasks, such as automatic labeling of images. Therefore, in one embodiment, a recurrent neural network is trained with respect to a specific piece of functionality in environment 100 of FIG. 1. For example, a recurrent neural network may be trained and utilized as part of image processing unit 124 to automatically label images.

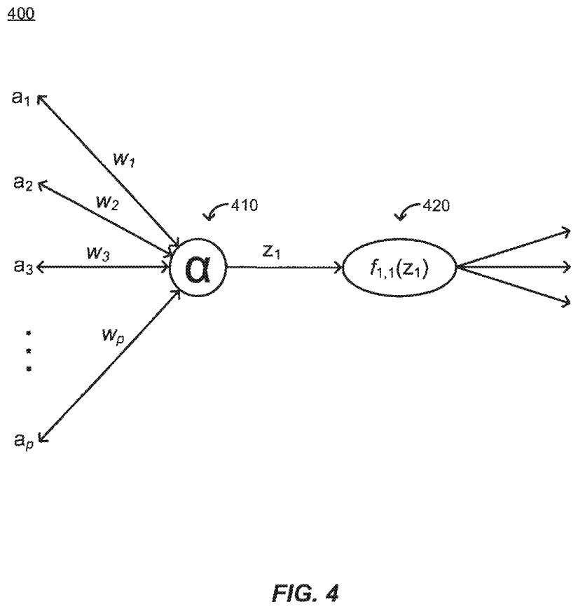

FIG. 4 depicts an example neuron 400 that corresponds to the neuron labeled as “1,1” in hidden layer 304-1 of FIG. 3, according to one embodiment. Each of the inputs to neuron 400 (e.g., the inputs in the input layer 302) is weighted such that input a₁ through aₚ corresponds to weights w₁ through wₚ as determined during the training process of neural network 300.

In some embodiments, some inputs lack an explicit weight, or have a weight below a threshold. The weights are applied to a function a (labeled by reference numeral 410), which may be a summation and may produce a value z₁ which is input to a function 420, labeled as f_{1,1}(z₁). The function 420 is any suitable linear or non-linear function. As depicted in FIG. 4, the function 420 produces multiple outputs, which may be provided to neuron(s) of a subsequent layer, or used as an output of neural network 300. For example, the outputs may correspond to index values of a list of labels, or may be calculated values used as inputs to subsequent functions.

It should be appreciated that the structure and function of the neural network 300 and neuron 400 depicted are for illustration purposes only, and that other suitable configurations exist. For example, the output of any given neuron may depend not only on values determined by past neurons, but also on future neurons.

### Exemplary Claim Data

As noted above, the methods and systems described herein are capable of analyzing decades of insurance claims to build neural network models, and the formatting of insurance claims may change significantly from decade to decade, even year to year. Flexibility has been built into the methods and systems described herein, which allows insurance claims in different formats to be processed and analyzed.

The specific manner in which the one or more neural networks employ machine learning to label and/or quantify risk may differ depending on the content and arrangement of training documents within the historical insurance claims (e.g., historical insurance claims 108 of FIG. 1 and historical insurance claims 270 of FIG. 2) and the input data provided by customers or users of the trend detection server or retrieved by the trend detection server (e.g., input data 102 of FIG. 1 and the data collected by input data collection application 216 of FIG. 2), as well as the data that is joined to the historical insurance claims and input data, such as customer profile 160 of FIG. 1 and customer profile 272 of FIG. 2, noninsurance data included in the input in FIG. 1.

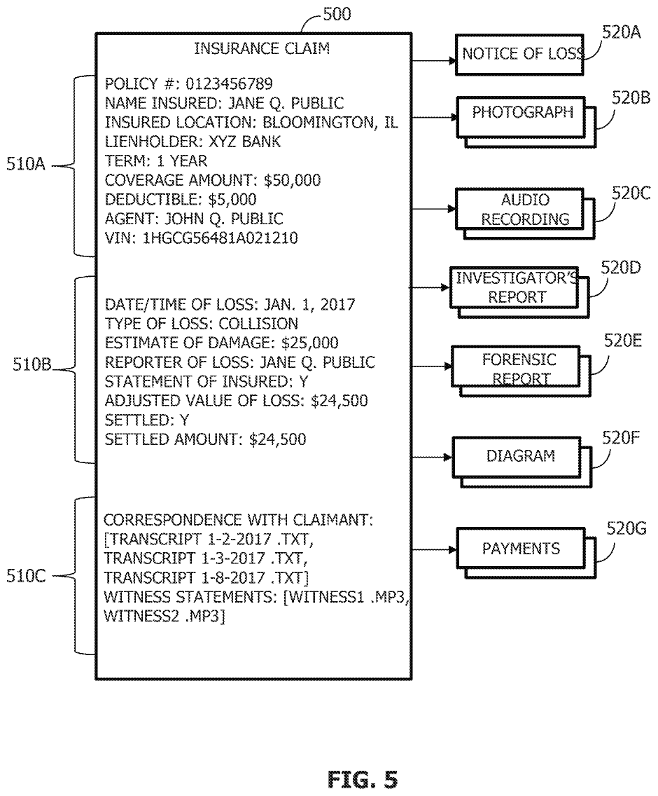

The initial structure of the neural networks (e.g., the number of neural networks, their respective types, number of layers, and number of neurons per layer) also affects the manner in which the trained neural network processes the input and insurance claims. Also, as noted above, the output produced by neural networks may be counter-intuitive and very complex. For illustrative purposes, examples will now be discussed in connection with FIG. 5.

FIG. 5 depicts text-based content of an example insurance claim 500 that is processed using an artificial neural network, such as neural network 300 of FIG. 3 or a different neural network generated by neural network unit 150 of FIG. 1 or neural network training application 264 of FIG. 2. The term “text-based content” as used herein includes printing characters (e.g., characters A-Z and numerals 0-9), and non-printing characters (e.g., whitespace, line breaks, formatting, and control characters). Text-based content may be in any suitable character encoding, such as ASCII or UTF-8 and may include HTML.

Although text-based-content is depicted in the embodiment of FIG. 5, as discussed above, claim data may include images, including hand-written notes, and the trend detection server may include a neural network trained to recognize hand-writing and to convert hand-writing to text. Further, “text-based content” may be formatted in any suitable data format, including structured query language (SQL) tables, flat files, hierarchical data formats (e.g., XML, and JSON) or as other suitable data format. In some embodiments, image and audio data are fed directly into the neural network(s) without being converted to text first.

With respect to FIG. 5, insurance claim 500 includes three sections 510a-510c, which respectively represent policy information, loss information, and external information. Policy information 510a comprises customer profile and includes information about the insurance policy under which the claim has been made, including the person to whom the policy is issued, the name of the customer and any additional customers, and the location of the customer. Policy information 510a is read, for example, by input analysis unit 120 analyzing insurance claims such as historical insurance claims 108 and individual claims, such as claims 110-1 through 110-n. Vehicle information may be included in policy information 510a, such as a vehicle identification number (VIN).

Additional information about the customer and the vehicle (e.g., make, model, and year of manufacture) may be obtained from data sources and joined to input data. For example, additional customer profile may be obtained from customer profile 160 or customer profile 272, and additional vehicle data may be obtained from asset data 162 and asset data 274. In some embodiments, make and model information is included in the insurance claim 500, and the additional information may be of vehicle attributes (e.g., the number of passengers that the vehicle seats, or the available options).

In addition to policy information 510a, insurance claim 500 includes loss information 510b. Loss information generally corresponds to information regarding a loss event in which a vehicle covered by the policy listed in policy information 510a has sustained loss, and may be due to an accident or other peril. Loss information 510b may indicate the date and time of the loss, the type of loss (e.g., whether collision or comprehensive), a cause of loss or cause of loss code, repair cost, replacement cost, whether personal injury occurred, whether the customer made a statement in connection with the loss, whether the loss was settled, and if so for how much money.

In some embodiments, more than one loss is represented in loss information 510b. For example, a single accident may give rise to multiple losses under a given policy, such as two vehicles involved in a crash operated by vehicle operators not covered under the policy. In addition to loss information, insurance claim 500 may include external information 510c, including but not limited to correspondence with the vehicle operator or statements made by the vehicle operator. External information 510c may be textual, audio, or video information. The information may include file name references, or may be file handles or addresses that represent links to other files or data sources, such as linked data 520a-g. It should be appreciated that although only links 520a-g are shown, more or fewer links may be included, in some embodiments.

Insurance claim 500 may include links to other records, including other insurance claims or data. For example, insurance claim 500 may link to notice of loss 520a, one or more photographs or digital images 520b, one or more audio recordings 520c, one or more investigator's reports 520d, one or more forensic reports 520e, one or more diagrams 520f, and one or more payments 520g. Data in links 520a-520g may be processed by a trend detection server such as trend detection server 104. For example, as described above, each claim may be processed and analyzed by input analysis unit 120.

For auto insurance claims, insurance claim 500 may also include, or include links to, vehicle data. For homeowners insurance claims, insurance claim 500 may also include, or include links to, home data.

In some embodiments, trend detection server 104 includes instructions which cause input analysis unit 120 to retrieve, for each link 520a-520g, all available data or a subset thereof. Each link is processed according to the type of data contained therein; for example, with respect to FIG. 1, input analysis unit 120 may process, first, all images from one or more photographs 520b using image processing unit 124. Input analysis unit 120 may process audio recordings 520c using speech-to-text unit 122.

In some embodiments, a relevance order is established, and processing is completed according to that order. For example, portions of claim data related to certain types of emerging trends are identified and processed first. For example, portions or fields of claim data related to claim severity, frequency, cause of loss, or peril are analyzed first to identify emerging trends. Once an emerging trend has be identified, then other portions of the claim data, or additional data that are most pertinent to confirming or verifying the trend may be identified and processed next.

In the example embodiment, once the various input data comprising insurance claim 500 has been processed, the results of the processing is passed to a text analysis unit, and then to neural network. If the trend detection server is being trained, then the output of input analysis unit 120 may be passed directly to neural network unit 150. The neurons of the first input layer of the neural network may be configured such that each neuron receives particular input(s) corresponding to one or more pieces of information from policy information 510a, loss information 510b, and external information 510c.

In the exemplary embodiment, one or more input neurons are configured to receive particular input(s) from links 520a-520g. If the trend detection server is being used to accept input to predict or identify an emerging trend in claim data, then the processing begins with the use of an input collection application, as discussed with respect to one embodiment in FIG. 2.

In some embodiments, analysis of input entered by a user is performed on a client device, such as client device 202. In that case, output from input analysis is transmitted to a server, such as server 204, and is passed directly as input to neurons of an already-trained neural network, such as a neural network trained by neural network training application 264.

In one embodiment, a new insurance claim is predicted directly by a neural network model trained on historical insurance claims 108, without the use of any labeling. For example, a neural network is trained with input parameters corresponding to policy information 510a, loss information 512b, external information 512c, and linked information 520a-520g.

In the example embodiment, the trained model is configured so that inputting sample parameters, such as those in the example insurance claim 500 accurately predict or identify emerging trends in insurance claims, such as increasing estimates of damage, faulty components causing damage, or cost of repair/replacement. In this case, random weights may be chosen for all input parameters.

In one embodiment, the trend detection server may modify the information in an insurance claim. For example, the trend detection server generates a series of labels as described above that pertain to a given claim. The labels are saved in a risk indication data store, such as trend indication data 142 with respect to FIG. 1. Next, the labels and corresponding weights are received by trend analysis platform 106, where they are used in conjunction with base rate information to predict a claim loss value.

In some embodiments, information pertaining to the claim, such as the coverage amount and vehicle type from policy information 510a, is passed along with the labels and weights to trend analysis platform 106 and is used in the computation of a claim loss value. After being computed, the claim loss value is associated with the claim, for example by writing the amount to the loss information section of the insurance claim (e.g., to the loss information section 510b of FIG. 5).

### Another Exemplary Insurance Claim

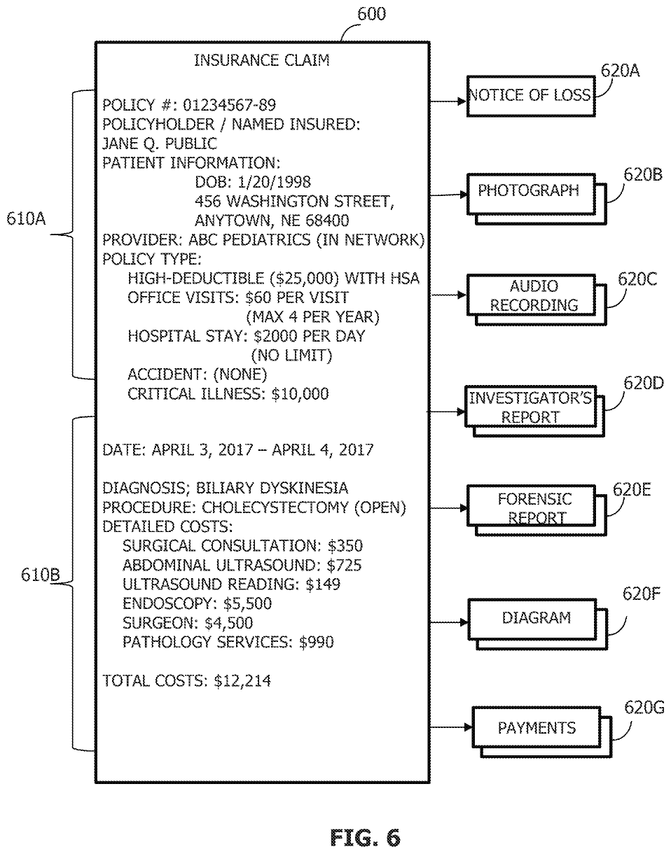

FIG. 6 depicts text-based content of another exemplary insurance claim 600. Insurance claim 600 may be a health insurance claim 600, and may be processed by a machine-learning model in accordance with various aspects of the present disclosure, such as emerging trend training model system 200 of FIG. 2, for example.

Although text-based-content is depicted in the embodiment of FIG. 6, as discussed above, data input and/or used as part of the insurance claim may include images, including hand-written notes. The trend detection server (e.g., a machine-learning model) may include a neural network trained to recognize hand-writing and to convert hand-writing to text. In some embodiments, image and audio data are fed directly into the neural network(s) without being converted to text first.

With respect to FIG. 6, insurance claim 600 includes two sections 610a-610b, which respectively represent policy information and loss information (i.e., the cost of health-related services rendered). Policy information 610a may include information about the insurance policy under which the claim has been made, including the person to whom the policy is issued, contact information, the type of plan, deductibles, or maximum payouts per year. Policy information 610a may be read, for example, by trend detection server 104.

Additional information about the customer (e.g., location, if the issue was related to a pre-existing condition, historical insurance claims, historical telematics data, or family medical history) may be obtained from various data sources to supplement the input data included with the insurance claim 600. In some embodiments, in addition to policy information 610a, the insurance claim 600 includes loss information 610b. In the context of health insurance, the loss information generally corresponds to costs associated with a particular medical condition or accident that necessitated some type of medical treatment for which a claim is submitted. In the context of a life insurance claim, the loss information 610b corresponds to the total payout in accordance with the life insurance policy.

The loss information 610b may include the total fees, the date and time the services were rendered, whether personal injury occurred, or whether medical professionals made any statements in connection with the loss. For instance, the loss information 610b may include (for health insurance, as shown in FIG. 6) a medical diagnosis, services rendered, details associated with the procedures required, and the length of a hospital stay. For life insurance policy claims (not shown), the loss information 610b may further include, for instance, additional details such as a time and cause of death and whether an autopsy was performed.

In addition to the loss information 610b, the insurance claim 600 may include additional information such as linked data 620a-g. It should be appreciated that although only links 620a-g are shown in FIG. 6, more or fewer links may be included, in some embodiments. Insurance claim 600 may link to notice of loss 620a, one or more photographs 620b, one or more audio recordings 620c, one or more investigator's reports 620d, one or more forensic reports 620e, one or more diagrams 620f, and/or one or more payments 620g. Data in links 620a-620g may be processed by a trend detection server 104. Moreover, as described above, each insurance claim (or various details associated with each claim) may be used as inputs to a neural network as part of training a machine-learning model.

In the exemplary embodiment, instructions stored in input analysis unit 120 cause input analysis unit 120 to retrieve, for each link 620a-620g, all available data or a subset thereof. The data represented by each of links 620a-620g may be included as part of the claim data, as part of the customer profile, and/or as part of any other suitable data. Each of links 620a-620g are also processed, weighted, and/or analyzed according to the type of data contained therein. For instance, a trend detection server analyzes images included and/or associated with photograph link 620b using any suitable type of image processing to recognize, classify, and/or categorize images (e.g., endoscopic images or ultrasound images) in a health or life insurance claim. To provide another example, a trend detection server 104 analyzes audio recordings (e.g., doctor's notes, annotations, or telephone calls) included and/or associated with audio recording link 620c using a speech-to-text algorithm to translate audio to text for use in a health or life insurance claim.

In various aspects, a relevance order may be established for each of the links 620a-620g, and processing of the data associated with each respective link may be completed according to that order. For example, portions of a claim that are identified as most dispositive of risk are identified and processed first. If they are dispositive of pricing, then processing of further claim elements is abated to save processing resources. In one embodiment, once a given number of labels is generated (e.g., 50), processing is automatically abate.

Once the various input data comprising insurance claim 600 have been processed, instructions stored in an input analysis unit may cause that unit, in one aspect, to execute a text-based analysis of the input data, and output the processed data for further processes in the trend detection server. For example, if the machine-learning model is being trained, then the output of the text-based analysis is passed to the particular model as part of the training process. Using the aforementioned neural network as an example, the neurons of a first input layer of the neural network are trained such that each neuron receives particular input(s) that corresponds to one or more pieces of information from policy information 610a and loss information 610b. Similarly, one or more input neurons are configured to receive particular input(s) from links 620a-620g.

In various aspects, the data inputs provided by the insurance claim 600 and/or other information used to train and apply the machine-learning model are useful to make various predictions associated with insurance claims (e.g., life and health insurance claims), and/or identify certain emerging trends of the insurance claims. For instance, emerging trends in claim frequency or severity by region may be flagged for further analysis or verification.

In one aspect, the trend detection server may also modify the information in an insurance claim. For example, the trend detection server produces a series of labels as described above that pertain to a given claim. The labels may then be weighted in accordance with their relevance, or contribution, towards claim loss value. The labels and corresponding weights are then used in conjunction with base rate information to predict a claim loss value. Once computed, the claim loss value is associated with the claim by writing the amount to the loss information section of the insurance claim (e.g., to the loss information section 610b of FIG. 6).

### Additional Insurance-Related Data Fields

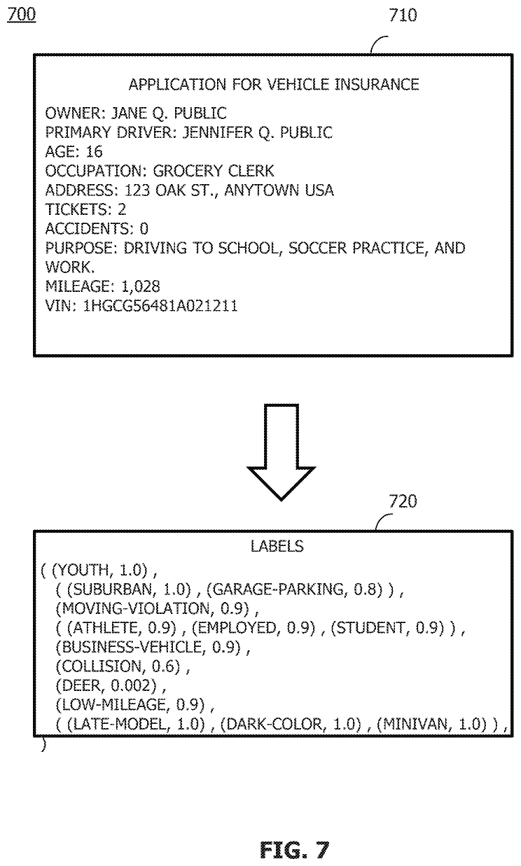

Turning to FIG. 7, a flow diagram for an exemplary computer-implemented method 700 of determining trend indicators from vehicle operator information is provided. In the exemplary embodiment, the method 700 is implemented by a processor (e.g., processor 250) or a portion of trend detection server 104, including input analysis unit 120, pattern matching unit 128, natural language processing unit 130, and neural network unit 150. The processor 210 of a client device 202 may cause an input data collection application 216 to acquire application input 710 from a user of a client device 202.

In the example embodiment, the processor 210 further executes the input data collection application 216 to cause the processor 210 to transmit application input 710 from the user via network interface 214 and a network 206 to a server (e.g., server 204). Processor 250 of server 204 causes module 254 of server 204 to process application input 710. Input analysis application 260 analyzes application input 710 according to the methods describe above. For example, vehicle information may be queried from asset data 274. A VIN number in application input 710 may be provided as a parameter to asset data 274.

In the example embodiment, asset data 274 may return a result indicating that a corresponding vehicle was found in asset data 274, and that it is a gray minivan that is one year old. Similarly, application input 710 is provided to a natural language processing unit (e.g., NLP unit 130), which returns a structured result indicating that the vehicle is being driven by a person who is an employed student athlete. The result of processing the application input 710 is provided to a trend identification unit (e.g., trend identification unit 140), which applies the input parameters to a trained neural network model.

In one embodiment, the trained neural network model produces a set of labels and confidence factors 720. The set of labels and confidence factors 720 contain labels that are indicative of the application input 710 (e.g., LOW-MILEAGE) or that are queried based upon information provided in the application input 710 (e.g., MINIVAN, based upon VIN). The set of labels and confidence factors 720 may include additional labels (e.g., COLLISION and DEER) that are not evident from the application input 710 or any related/queried information. After being generated by the neural network, the set of labels and confidence factors 720 are then saved to an electronic database such as trend indication data 276, and/or passed on to a trend analysis platform 106, whereupon a total risk is computed and used in a pricing quote provided to the user of client device 202.

It should be appreciated that many more types of information may be extracted from the application input 710. In one embodiment, the pricing quote is a weighted average of the products of label weights and confidences. The method 700 may be implemented in response to a vehicle operator accessing client server 202 for the purpose of applying for an insurance policy, or adding an additional customer to an existing policy. The method may include additional, less, or alternative actions, including those discussed elsewhere herein.

### Additional Exemplary Data Set

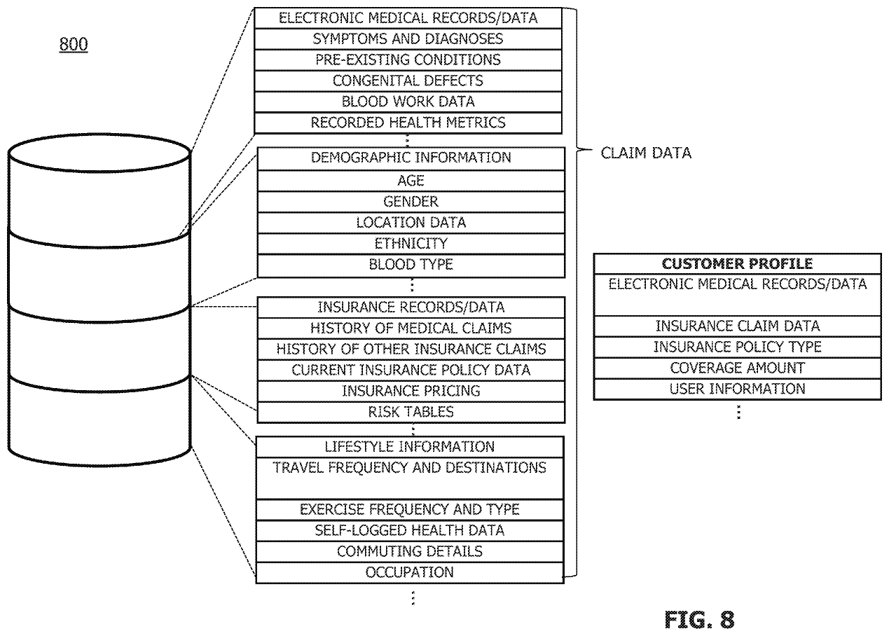

Turning to FIG. 8, an exemplary insurance claim 800 including claim data and customer profile, in accordance with certain aspects of the present disclosure is provided. A data aggregation module may facilitate a processing unit (e.g., via a communication unit) aggregating various portions of data to form the claim data. Customer profile may stay relatively unchanged. Claim data may dynamically evolve and change and may include information about the customer's office visit or past insurance claims. Additionally, the data aggregation module may facilitate the processing unit receiving and storing customer profile, which is used to calculate an insurance premium for a specific type of insurance product. The claim data and customer profile may thus represent data that is received, accessed, and/or stored in any suitable portion of a trend detection server del (e.g., a memory unit) and/or another suitable storage device that is accessible by the trend detection server (e.g., one or more back-end components).

It will be understood that the examples shown in FIG. 8 associated with the claim data and customer profile, such as the electronic medical records, demographic information, insurance records, or lifestyle information, are but some examples of the types of information that may be relevant to train and execute a machine-learning model for one or more particular users. The claim data and customer profile may thus include, for example, any suitable number and/or type of information that is useful or otherwise relevant to calculate health and/or life insurance policies for one or more users, including social media information gathered with the user's permission or affirmative consent. For example, although not illustrated in FIG. 8, the claim data may include psychographic information that is relevant to or indicative of the risk of insuring a user for a particular type of insurance policy.

As shown in FIG. 8, electronic medical records for various users may include data such as a history of various symptoms and diagnoses, pre-existing conditions, congenital defects, a history of blood work data (e.g., triglycerides or cholesterol levels), and other recorded health metrics (e.g., height, weight, and BMI). Thus, the electronic medical records may include any suitable type of information that is relevant to assessing an initial risk of providing health and/or life insurance for a user and/or intervening actions that may be taken by the user to reduce this initially-assessed risk, which may represent part of the claim data that is used as training data for a machine-learning model, as further discussed herein.

To provide another example, as shown in FIG. 8, demographic information may include age (or age bracket), gender, location data such as the user's current address or residential region, ethnicity, or blood type for various users. In various aspects, this demographic information may provide various insights when used as training data such that correlations may be made amongst similar users and compared to future users as part of a machine-learning model, as further discussed herein. For example, the demographic information may allow a correlation to be made among other users with similar demographic data, for which similar risk assessments may thus be identified.

As yet another example, insurance records may include, for various customers, a history of medical claims, a history of other types of insurance claims of the customers, current insurance policy information for the customers (e.g., policy numbers, dates, coverage, and premiums), insurance pricing information, risk tables and/or data mapping various conditions or behaviors to specific levels of risk. As further discussed herein, this insurance information may be used to train a machine-learning model by establishing an initial correlation between specific types of insurance policy information and customer profiles, and ultimately used for the identification of emerging trends in claim frequency and severity, causes of loss, or claim amount.

To provide an additional example, lifestyle information indicates, for several users, each user's general preference regarding various lifestyle choices, which represent preferences regarding how often each user prefers to travel (and where), how often a user receives a health-related checkup, how often each user exercises (and the type of exercise), self-logged health data (e.g., information from weight loss applications such as caloric intake, and data accessed via fitness trackers such as heart rate), how each user prefers to commute to work, or each user's occupation. Again, like the aforementioned demographic information and other data that may form part of the claim data, the lifestyle information may be utilized to identify risk correlations amongst users, which may then be used, for example, to predict future risks for similar users via the machine-learning model.

In various aspects, any suitable number and type of machine-learning model are implemented, and therefore the data selected from insurance claims, as well as the particular type of training process, are adapted to the particular type of a machine-learning model and/or artificial intelligence system that is implemented. For example, a machine-learning model is implemented in accordance with decision tree learning, association rule learning, an artificial neural network, deep learning, inductive logic programming, support vector machines, clustering, Bayesian networks, reinforcement learning, combined learning, representation learning, similarity and metric learning, sparse dictionary learning, genetic algorithms, rule-based learning, or a MapReduce programming model used in accordance with the HADOOP framework.

Generally, the overall process of training the machine-learning model may include defining the sample inputs, weighting these inputs, and defining one or more outputs that are determined using the weighted inputs. Based upon this initial training framework, the machine-learning model allows correlations to be made among different subsets of data within the claim data, correlations to be made among data contained in the data set and received customer profile, and/or specific predictions to be formulated. Over time, as noninsurance data becomes available, or as the claim data is updated, the trained machine-learning model may identify new correlations, vary the weighing of certain inputs, or change the inputs, such that different correlations may be made, the accuracy of predictions may be improved, and/or new predictions may be made.

For instance, the data contained as part of the claim data may represent time-series data, with each data point including a particular value and a corresponding indication of time at which the value was collected, observed, or generated by a particular data source. The time series data may be analyzed to detect an emerging trend in the time series using a machine learning model.

### Exemplary Repair Codes

In some embodiments, the claim data include repair codes and/or repair code data fields. For instance, U.S. Pat. No. 9,208,526 describes exemplary repair codes, and is incorporated herein in its entirety.

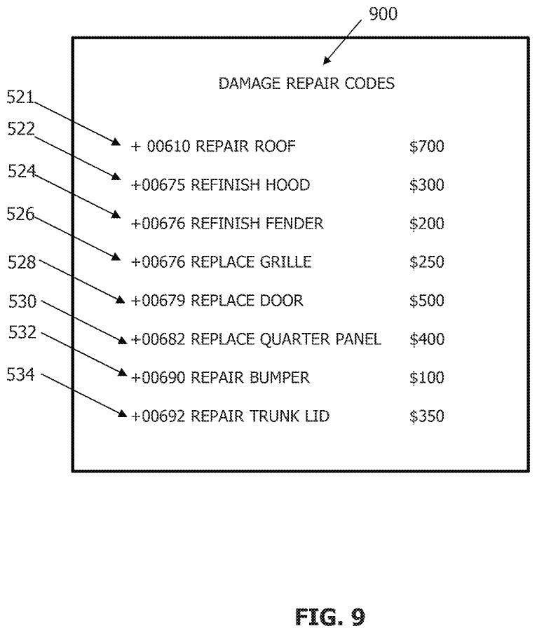

FIG. 9 depicts an example table 900 of damage repair codes for estimating the cost of repairing vehicle damage. The example table 900 includes example repair codes which may be a small subset of a larger set of repair codes. As mentioned above, the set of repair codes may include a separate repair code for each combination of vehicle characteristics such as make and model of the vehicle being repaired, the vehicle part being repaired, the type of repair for the vehicle part including whether the vehicle part needs to be repaired, refinished and/or replaced, or the extent of the damage to the vehicle part.

Each repair code may correspond to a cost estimate, where the cost estimate may be determined based upon collision data including historical loss information of similar type vehicles having similar type damage. For example, the associated cost estimate for a repair code corresponding to repairing the quarter panel of a Ford Taurus having moderate damage is determined by analyzing repair costs from historical loss information related to repairing quarter panels of Ford Tauruses having moderate damage from past collisions. In some embodiments, the repair codes are stored in a computer system and/or operatively coupled to a processing center, such as shown in FIGS. 1 and 2.

As shown in FIG. 9, repair code 00675 (reference 522) is associated with an instruction, “Refinish Hood,” and a cost estimate, $300. While the instruction for repair code 00675 (reference 522) does not specify the extent of the damage to the hood, or the make and model of the vehicle, repair code 00675 (reference 522) may be used for refinishing hoods of Honda Civics with light damage. In some embodiments, a separate repair code, for example, 10675 is used for refinishing hoods for vehicles of a different make and/or model with light damage.

Moreover, yet another repair code, for example, 02675, is used for refinishing hoods for Honda Civics with moderate damage. Further, in some embodiments, the set of repair codes are generated based upon additional or alternative vehicle characteristics and in other embodiments some of the above mentioned vehicle characteristics are omitted when generating the set of repair codes.

In the exemplary embodiment, repair code 00610 (reference 521) is associated with the instruction, “Repair Roof,” and a cost estimate of $700. Repair code 00676 (reference 524) is associated with the instruction, “Refinish Fender,” and a cost estimate of $200. Repair code 00676 (reference 526) is associated with the instruction, “Replace Grille,” and a cost estimate of $250. Repair code 00679 (reference 528) is associated with the instruction, “Replace Door,” and a cost estimate of $500. Repair code 00682 (reference 530) is associated with the instruction, “Replace Quarter Panel,” and a cost estimate of $400. Repair code 00690 (reference 532) is associated with the instruction, “Repair Bumper,” and a cost estimate of $100. Repair code 00692 (reference 534) is associated with the instruction, “Repair Trunk Lid,” and a cost estimate of $350.

In the exemplary embodiment, each of these repair codes is for the same vehicle make and model, for example, a Honda Civic, and is aggregated and/or combined to estimate the total cost of repair for a damaged Honda Civic. For example, by comparing crash information for a damaged Honda Civic to collision data, a list of damaged vehicle parts including the extent of the damage to each vehicle part are generated. A repair code from the set of repair codes is then assigned to each damaged vehicle part in the list based upon the vehicle characteristics for the damaged vehicle. For example, repair code 00679 (reference 528) is assigned when a door in the Honda Civic needs to be replaced. In some embodiments, repair code 00679 is assigned twice when two doors in the Honda Civic need to be replaced.

While the example table 900 depicts eight repair codes, this is merely for ease of illustration only. There may be hundreds or thousands of repair codes each corresponding to a different combination of vehicle characteristics. More specifically, each make and model may correspond to a separate subset of repair codes including each combination of vehicle characteristics. For example, repair codes 00600-00699 may correspond to Honda Civics, while repair codes 00700-00799 may correspond to Honda Accords. The make and model for the vehicle may be determined using the vehicle data for the damaged vehicle.

Moreover, in some embodiments, repair codes are also used for salvaging and/or scrapping purposes. For example, the repair code 19986 is used for salvaging hoods of Honda Civics in good condition. The associated cost estimate is a price estimate of the market value of the vehicle part assuming it is sold to a treatment facility or any other auto body shop. The price estimates for salvage repair codes may be aggregated to determine the total price that an insurance provider can recover by salvaging vehicle parts.

The salvage repair codes may have an inverse relationship with the other repair codes. For example, for the salvage repair codes, vehicle parts in better condition have higher associated price estimates, whereas for the other repair codes, the cost estimates become higher when there is more work that needs to be done to repair the vehicle part.

Further, the price estimate may be based upon the scarcity/demand for the vehicle part. For example, vehicle parts from a classic car (e.g., a 1964 Chevrolet Corvette) are in high demand because the car is no longer manufactured. The price estimate for repair of those vehicle parts then may be much higher than those of other repairs.

### Machine Learning

The computer-implemented methods discussed herein may include additional, less, or alternative actions, including those discussed elsewhere herein. The methods may be implemented via one or more local or remote processors, transceivers, servers, and/or sensors (such as processors, transceivers, servers, and/or sensors mounted on drones, vehicles or mobile devices, or associated with smart infrastructure or remote servers), and/or via computer-executable instructions stored on non-transitory computer-readable media or medium.

Additionally, the computer systems discussed herein may include additional, less, or alternative functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. For instance, machine learning may involve identifying and recognizing patterns in existing text or voice/speech data in order to facilitate making predictions for subsequent data. Voice recognition and/or word recognition techniques may also be used. Models may be created based upon example inputs in order to make valid and reliable predictions for new inputs.

Additionally or alternatively, the machine learning programs may be trained by inputting sample insurance claims or noninsurance data into the programs, such as data collected by drone, autonomous or semi-autonomous drone, image, mobile device, vehicle telematics, smart or autonomous vehicle, vehicle-mounted or home-mounted sensor, and/or intelligent home telematics data. The machine learning programs may utilize deep learning algorithms that may be primarily focused on pattern recognition, and may be trained after processing multiple examples. The machine learning programs may include deep or combined learning, semi-supervised learning, reinforcement or reinforced learning, Bayesian program learning (BPL), voice recognition and synthesis, image or object recognition, optical character recognition, and/or natural language processing—either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs so that, when subsequent inputs are provided, the processing element may, based upon the discovered rule, accurately predict the correct output. In unsupervised machine learning, the processing element may be required to find its own structure in unlabeled example inputs. Unsupervised trend detection algorithms may be used in some embodiments.

Based upon these analyses, the processing element may learn how to identify emerging trends in the insurance claims by analyzing text-based data, image data, model data, and/or other data in the insurance claims and noninsurance data.

### Exemplary Emerging Trend Detection

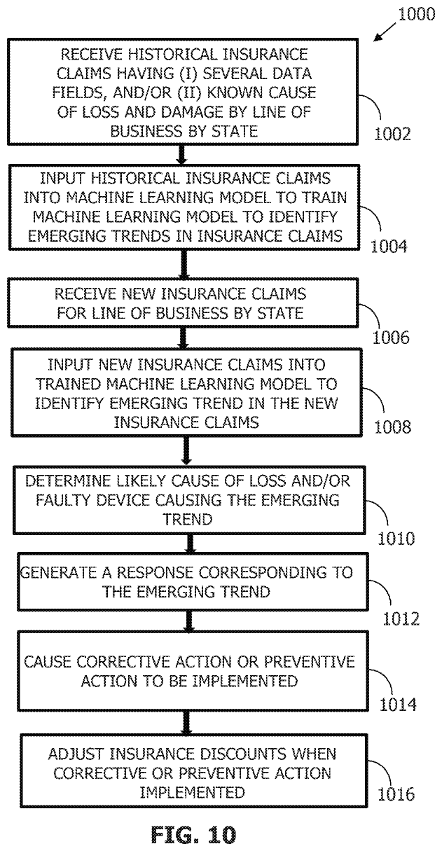

FIG. 10 depicts an exemplary computer-implemented method of detecting emerging trends in insurance claims 1000. In the example embodiment, the method 1000 includes, via one or more processors, servers, sensors, and/or transceivers, collecting or receiving historical insurance claims having several data fields 1002. The several data fields may include parameters, attributes, claim codes, claim-related codes, damage codes, repair codes, and/or other codes. For instance, the several data fields may relate to or include two- or three-digit codes, or alphanumeric codes, representing cause of loss or peril, such as wind, water, and hail. The historical insurance claims are associated with claims having known causes of losses or perils, and/or known amounts or estimated amounts, of damage and/or repair/replacement costs. The historical insurance claims may be characterized or categorized by line of business (such as auto, homeowners, renters, personal articles, health, or life insurance) by state.

The historical insurance claims may include data fields detailing, identifying, or describing cause of loss or peril, reported claims, claim severity, claim frequency, line of business (e.g., auto, home, and life), geographical area (such as state or city), damage, loss, injury, and/or other conditions associated with an insurance claim or insured asset. Additionally or alternatively, the historical insurance claims may include data fields detailing different expenses, such as claim expenses, litigation expenses, acquisition expenses, salaries, and underwriting expenses, travel expense and equipment expenses.

Other types of data may also be collected or received. For instance, customers may opt into a program in which they share certain types of data with their insurance provider. In return, risk-averse customers are entitled to insurance discounts or other insurance cost-savings. The other types of data may comprise noninsurance data such as vehicle data and home data. Vehicle data may include autonomous vehicle data, smart vehicle data, vehicle-mounted sensor data, and vehicle telematics data (such as braking, cornering, acceleration, GPS, and speed data), and mobile device data. Home data may include intelligent or smart home data, smart home sensor data, and/or home telematics data (such as data associated with smart device or appliance usage, device operation within a home, or water and electricity usage within a home).

In the exemplary embodiment, the method 1000 includes, via the one or more processors, inputting the historical insurance claims into a machine learning model to train the machine learning model to identify emerging trends in insurance claims 1004. Each trend is associated with an individual data field of the historical insurance claims, such as individual data fields related to cause of loss or peril, reported claims, claim severity, claim frequency, line of business (e.g., auto, home, and life), geographical area (such as state or city), damage, loss, or injury.

In the exemplary embodiment, the noninsurance data may also be input into the machine learning model to further train the machine learning model to identify emerging trends. For instance, patterns in device operation may emerge prior to device failure in some cases. As examples, autonomous vehicle sensors, smart appliance sensors, or smart home sensors that are failing may exhibit degrading electrical signatures or other patterns that the machine learning model is trained to identify based upon the noninsurance data.

In general, the emerging trends identified may relate to cause of loss or peril, reported claims, claim severity, claim frequency, line of business (e.g., auto, home, life, and health), geographical area (such as state or city), damage, loss, injury, and/or other conditions associated with an insurance claim or insured asset. The emerging trends identified may also relate to different expenses, such as claim expenses, litigation expenses, acquisition expenses, salaries, and underwriting expenses, travel expense and equipment expenses).

In the exemplary embodiment, the method 1000 includes receiving, via the one or more processors and/or associated transceivers, new insurance claims for a line of business by state 1006. As an example, new auto claims data for Texas may be collected, or new homeowners claims data for Illinois may be collected. The new insurance claims may have the same data fields, or additional or alternative data fields as the historical insurance claims. Other types of data like noninsurance data may be collected or received as well.

In some embodiments, the method 1000 includes inputting, via the one or more processors, the new insurance claims for a line of business by state into the trained machine learning model 1008. The trained machine learning model identifies emerging trends in the new insurance claims. In one embodiment, the trained machine learning model identifies patterns or trends in individual data fields within the new insurance claims, such as identifying up or down trends in new insurance claims having a specific cause of loss or a specific cause of loss code. In some embodiments, the new insurance claims are also used to update the machine learning model such as verifying or adjusting the level or degree of the identified emerging trend.

In some embodiments, the method 1000 includes determining, via the one or more processors and/or via the trained machine learning model, a likely cause of loss and/or a faulty device causing the emerging trend 1010. As used herein, a faulty device includes a device, component, or software program that does not function or does not meet the specifications when in operation. The historical insurance claims may reveal that for certain type of trend, such as an increase in claim frequency or severity for claims with a certain type of cause of loss may be likely due to a specific type of faulty device, such as a faulty vehicle-mounted or home-mounted sensor or smart device. As an example, water damage caused by a washer or refrigerator may likely be the result of a damaged or defective water hose. Water damage in a basement may be due to a leaking piping or valve.

In the exemplary embodiment, the method 1000 includes generating, via the one or more processors, a response corresponding to the emerging trend. The response includes one or more corrective actions intended to mitigate damage caused by the emerging trend, or one or more preventive actions to limit potential damage, to the insured assets that would be caused by the emerging trend if left unattended 1012. The corrective actions may include identifying customers impacted or potentially impacted by the emerging trend, and generating and transmitting a corresponding notification to the customers' mobile devices. Preventive actions may include identify customers whom will likely be impacted by the emerging trend in the future, such as customers who have the same type of devices or components that cause the emerging trend but the devices or components still function normally. The corrective actions or prevent actions may further include identifying repair or replacement parts to repair or replace the faulty device.

In some embodiments, the response may include adjust or revise insurance policies based upon the emerging trend so that the insurance policies better reflect the underlying risk. For example, if mold is the cause of the emerging trend of the increase in claim frequency. The insurance policies may be revised on the terms of coverage on mold.

In some embodiments, the response may include notifying the manufacturer of the faulty devices that cause the emerging trend. For example, if the faulty device is a certain model of tires by a manufacturer, the response may include notifying the manufacturer of the defective tires. The manufacturer may have more detailed data in finding out vehicles installed with that model of tires and are better equipped to take actions to mitigate damage or limit potential damage.

The responses corresponding to the emerging trends are not mutually exclusive to each other. For example, corrective actions, preventive actions, and adjustment of insurance policies may be all carried out, or one or two are carried out.

In the exemplary embodiment, the method 1000 includes causing, via one or more processors and/or associated transceivers, the responses to be implemented 1014. For instance, once repair or replacement devices are identified, they are ordered by one or more processors, or the one or more processors schedule a service appointment with a repair shop or other 3^{rd} party. The corrective actions or preventative actions may include the one or more processors automatically downloading or installing new software versions to replace faulty software associated with smart homes, smart sensors, smart appliances, smart vehicles, autonomous or semi-autonomous vehicles, and/or autonomous or semi-autonomous vehicle features or systems.

In the exemplary embodiment, the method 1000 further includes monitoring, via one or more processors and/or transceivers, whether the corrective action or preventive action has been completed, and if so, adjusting an insurance discount or premium for a customer 1016 to reflect a decrease in risk. The method 1000 may include additional, less, or alternative actions, including those discussed elsewhere herein.

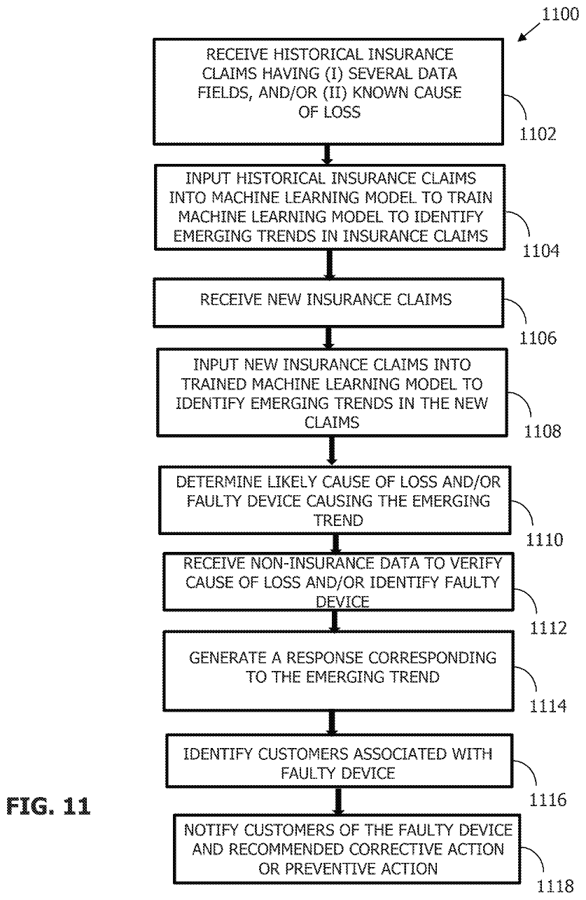

FIG. 11 depicts another exemplary computer-implemented method of detecting emerging trends in insurance claims 1100. The method 1100 may include receiving or collecting historical insurance claims having several data fields 1102. The insurance claims may be associated with claims having known or actual cause of loss, and actual or estimated damage or repair/replacement costs. The insurance claims may be organized by line of business by state, in some embodiments.

In the example embodiment, the method 1100 includes inputting the historical insurance claim into a machine learning model to train the machine learning model to identify emerging trends in the insurance claims 1104. The method 1100 may include receiving new insurance claims newly filed/submitted 1106. The new insurance claims may be received or organized by line of business and/or by state, in some embodiments.

In the example embodiment, the method 1100 includes inputting the new insurance claims into the trained machine learning model that is trained to identify emerging trends in insurance claims 1108. Emerging trends may relate to (i) new auto claims of new make or models of automobiles, (ii) new auto claims for automobiles having specific types of autonomous or semi-autonomous systems or features, (iii) new auto claims for autonomous vehicles having the same type of autonomous or semi-autonomous features, systems, or software, (iv) new auto claims for vehicles having the same type of components, such as the same type clutch, transmission, steering wheels, entertainment systems, tires, drive trains, brakes, or power steering, (v) new homeowners claims for houses with the same type of roofing, shingles, windows, doors, siding, lighting, cabinets, tiles, plumbing, piping, toilets, appliances, smart appliances, smart doors, smart lighting, smart toilets, smart plumbing or piping, or smart sprinkler systems, and/or (vi) new homeowners claims for houses equipment for intelligent or smart functionality, systems, and features, which may include various smart sensors and software interacting with a smart home controller. In some embodiments, the new insurance claims are also used to update the machine learning model such as verifying or adjusting the level or degree of the identified emerging trend.

In the example embodiment, if an emerging trend is identified by the machine learning model, such as increase in claim frequency or severity in auto or homeowners claims in Texas, further analysis of the insurance claims is performed. For instance, once an emerging trend is identified, the method 1100 includes analyzing, via one or more processors or a machine learning model, the insurance claims to determine or predict a likely cause of loss for the new claims, or determine or identify a likely faulty device causing the emerging trend in new insurance claims 1110.

For instance, if the same make and model of an autonomous vehicle is experiencing an uptick in claims, the root cause of the claims may be that one of the autonomous vehicle systems was currently upgraded to include a new device, component, or software version that is faulty or malfunctioning. If the homes in a given state are experiencing an uptick in claims, the root cause of the claims may be faulty manufacturing or construction materials used throughout a state or region. If smart homes with the same smart home functionality are experiencing an uptick in a given type of claims, the root cause may be associated with malfunctioning smart home sensors, components, or software, e.g., smart home security systems for theft claims or smart fire suppression systems or fire claims.

In one embodiment, the claim data of the insurance claims may have several data fields, such as two- or three-digit numbers, or alphanumeric codes. The data fields may each be associated with a predetermined likely cause or causes of loss, which may be organized in a table. If an emerging trend is detected in the insurance claims, one or more processors may identify which data fields are prevalent or otherwise are above normal or deviate from a baseline within the new insurance claims. Those outlier or abnormal data fields may be used to access the table of causes of loss, and retrieve the corresponding likely cause or causes of loss, such as a faulty sump pump or leaking piping for flood or water damage in a basement.

In the exemplary embodiment, once a likely cause of loss is identified, the method 1100 includes receiving noninsurance data. The method 1100 may include gathering, receiving, or collecting noninsurance data from the customers associated with the new insurance claims and/or other customers 1112.

The noninsurance data may be used to verify the cause of loss and/or identify a faulty device. For instance, the data gathered from an autonomous vehicle may reveal that one or more components or sensors are not operating or sending control signals as intended, or that the one or more software versions controlling autonomous vehicle features is corrupted or has a bug or flaw.

In the exemplary embodiment, the method 1100 includes generate a response corresponding to the emerging trend. The response may include determining corrective actions to mitigate or preventive actions to limit damage to insured assets cause by the identified faulty device 1114. For instance, if an autonomous vehicle feature has a faulty component or sensor, replacement parts may be ordered, via one or more processors, and maintenance with a repair facility may be automatically scheduled via the one or more processors. Or if an autonomous vehicle feature has a corrupted or outdated software version, the one or more processors, may automatically replace the faulty software version with an updated software version with vehicle owner's permission.

In the exemplary embodiment, the method 1100 includes identifying customers associated with, or having the faulty device 1116. The method 1100 may include notifying the customers of the faulty device and recommendations to mitigate the corresponding elevated risk of damage to insured assets 1118. For instance, one or more processors, may generate an electronic notification and transmit it to the impacted customers' mobile devices.

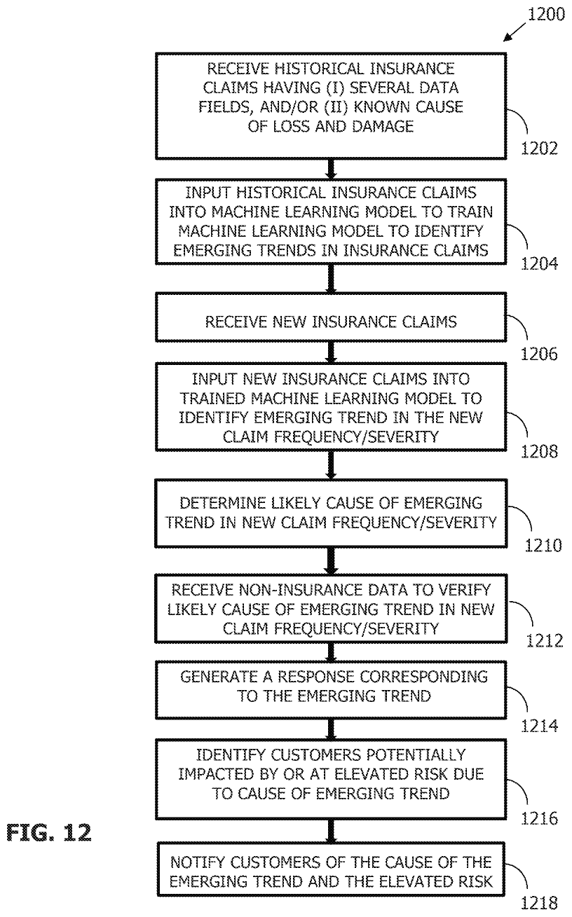

FIG. 12 depicts another exemplary computer-implemented method of detecting emerging trends in insurance claims 1200. In the example embodiment, the method 1200 includes receiving historical insurance claims having several data fields 1202. The insurance claims are associated with claims having known or actual cause of loss, and actual or estimated damage or repair/replacement costs. The insurance claims may be organized by line of business by state, in some embodiments.

In the example embodiment, the method 1200 includes imputing the historical insurance claims into a machine learning model to train the machine learning model to identify emerging trends in insurance claims such as abnormalities in new claim frequency or severity 1204. The method 1200 further includes receiving new insurance claims being filed/submitted 1206. The new insurance claims may be received or organized by line of business and/or by state, in some embodiments.

In the example embodiment, the method 1200 includes inputting the new insurance claims into the trained machine learning model that is trained to identify emerging trends in new claim frequency and/or severity 1208. For instance, emerging trends in the frequency or severity of claims may involve: hail damage for houses having a certain type of roofing, fire damage for houses having a certain type of alarm or sprinkler system; damage resulting to houses having a specific type of concrete, wood, or other construction material; collisions involving autonomous vehicles having a specific type of autonomous or semi-autonomous feature; vehicle having a specific version of software; and/or homes having a specific version of software. The new insurance claims may also be used to update the machine learning model such as verifying or adjusting the level or degree of the identified emerging trend.

In the example embodiment, the method 1200 includes determining a likely cause of the emerging trend of abnormality in new claim frequency and/or severity 1210. For instance, individual types of roofing, concrete, or other construction materials may be determined, via one or more processors, to be likely defective or faulty. Individual software versions running smart or autonomous vehicles, or smart home functionality, may be determined, via one or more processors, to be likely defective or faulty. Certain smart devices, appliances, or vehicles may be determined, via one or more processors, to be likely defective or faulty.

In the example embodiment, the method 1200 may include collecting or receiving noninsurance data from one or more customers to verify the likely cause of the emerging trend in the new claim frequency and/or severity 1212. In some embodiments, the one or more processors may remotely perform diagnostic tests on sensors and smart devices, vehicles, and appliances to determine or verify whether the devices and components are operating as intended or need repair or replacement.

In the example embodiment, the method 1200 includes generating a response corresponding to the emerging trend. The response may include determining, via one or more processors, corrective actions to mitigate or preventive actions to limit damage to insured assets caused by the root cause of the emerging trend 1214. The method 1200 further includes identifying, via one or more processors, customers potentially impacted by, or at an elevated risk due to the emerging trend and/or the cause of the emerging trend 1216; and/or notifying, via one or more processors, the customers at an elevated risk due to the emerging trend or the cause of the emerging trend 1218.

### Exemplary Supervised Machine Learning Techniques

In some embodiments, the supervised machine learning techniques discussed herein use one or more data fields in the claim data of insurance claims as a feature to model. Each data field of claim data is used as input into a machine learning model trained to identify emerging trends in the claim data, which are predicted “labels” for the claim data. For instance, the machine learning model may predict an increase in claim severity or frequency by line of business by state.

In one aspect, a computer-implemented method of detecting emerging trends in insurance claims and/or other data is provided. The method may include (1) receiving, via one or more processors and/or associated transceivers, new insurance claims, the new insurance claims including data in several data fields; (2) inputting, via one or more processors, the new insurance claims into a machine learning model trained to identify or detect emerging trends in the new insurance claims and/or the one or more of the several data fields; (3) identifying or detecting, via one or more processors executing the machine learning model, an emerging trend in the new insurance claims and/or one of the several data fields; and/or (4) generating, via one or more processors, a response corresponding to the emerging trend. The response may include determining one or more corrective actions that mitigate or preventive action to limit damage to insured assets caused by the emerging trend. The response may include adjusting the insurance policy based upon the emerging trend. The method may include additional, less, or alternative actions, including those discussed elsewhere herein.

For instance, the one or more corrective actions may include generating, via one or more processors, an electronic warning report that indicates the emerging trend in the new insurance claims and/or the one of the several data fields. Additionally or alternatively, the one or more corrective actions may include identifying, via one or more processors, a faulty device causing the emerging trend. Preventive actions may include identify customers whom will likely be impacted by the emerging trend in the future, such as customers who have the same type of devices that cause the emerging trend. Preventive actions may further include notifying those customers and suggesting repairs to them.

In some embodiments, the new insurance claims relate to, or are associated with, auto insurance claims, and the faulty device is associated with an autonomous vehicle feature or system employed by an autonomous or semi-autonomous vehicle, such as a sensor, electronic component, or software version. Additionally or alternatively, the new insurance claims relate to, or are associated with, homeowners insurance claims, and the faulty component is associated with a smart or intelligent home feature or system, such as a sensor, electronic component, or software version.

In some embodiments, the method includes identifying, via one or more processors, a faulty device causing the emerging trend; identifying, via one or more processors, customers having a device, appliance, vehicle, or home having the faulty device; generating, via one or more processors, an electronic notification detailing the faulty device and/or recommended action (such as repair or replacement) to alleviate risk associated with the faulty device; and/or transmitting, via one or more processors and/or associated transceivers, the electronic notification to a mobile device associated with the customer.

In one embodiment, the method include identifying, via one or more processors, a faulty device causing the emerging trend, where the insurance claims comprise auto insurance claims. Identifying, via one or more processors, a faulty device causing the emerging trend includes collecting, via one or more processors, vehicle data generated by one or more vehicles. The method may further include verifying, via one or more processors, that the faulty device causing the identified emerging trend, or otherwise is need of repair or replacement, based upon processor analysis of the vehicle data collected. The faulty device may be verified using the vehicle data prior to one or more corrective actions being determined. The one or more corrective actions may include repairing or replacing the faulty device.

In another embodiment, the method includes identifying, via one or more processors, a faulty device causing the emerging trend, where the insurance claims comprise homeowners insurance claims. Identifying, via one or more processors, a faulty device causing the emerging trend includes collecting, via one or more processors, home data generated by one or more homes. The method may further comprise verifying, via one or more processors, that the faulty device causing the emerging trend identified, or otherwise is need of repair or replacement, based upon processor analysis of the home data collected. The faulty device may be verified using the home data prior to one or more corrective actions being determined. The one or more corrective actions may include repairing or replacing the faulty device.

In the example embodiment, the machine learning model is trained to identify or detect trends in insurance claims (or data in one or more of the several data fields) by inputting historical insurance claims (including data in one or more of the several data fields) into the machine learning model. Additionally or alternatively, the machine learning model is trained to identify or detect trends in insurance claims, at least in part by, building a baseline for each of the several data fields, and an emerging trend is identified when one of the data fields deviates from the respective baseline by a predetermined threshold. The threshold may be a percentage or an amount deviated from the baseline.

The new insurance claims and/or the historical insurance claims may relate to auto, homeowners, personal articles, life, health, disability, or workers compensation insurance claims. Additionally or alternatively, the new insurance claims and/or the historical insurance claims may include several data fields related to claim severity, claim frequency, peril or cause of loss, coverage, coverage amount, line of business (such as auto or homeowners insurance), and/or or geographical area. Additionally or alternatively, the new insurance claims and/or the historical insurance claims may include several data fields related to one or more types of expense information, including claims expenses, litigation expenses, acquisition expenses, salaries, underwriting expenses, travel expenses, and/or equipment expenses.

In some embodiments, the emerging trend in the new insurance claims or in one of the data fields identified are further used, by one or more processors, to predict future claims and/or causes of loss. For instance, the new insurance claims comprise auto insurance, and the trend detected or identified is an increase in auto claims severity or frequency due to a faulty vehicle component. The faulty vehicle component may include one or more of blown tires, safety recall components, or steering wheels. Additionally or alternatively, the faulty vehicle component may include one or more of sensors, software or software versions, and/or electronic components related to autonomous vehicle features, systems, or technologies.

In one embodiment, the new insurance claims relate to auto insurance, and the emerging trend detected or identified is an increase in auto claims severity or frequency due to a particular peril or cause of loss, wherein the cause of loss is water damage, or otherwise water-related.

In another embodiment, the new insurance claims relate to homeowners insurance, and the emerging trend detected or identified is an increase in homeowners insurance claims severity or frequency due to a faulty device. For instance, the faulty device includes one or more of sensors, software or software versions, and/or electronic components related to intelligent home or smart home features, systems, or technologies, including security alarms, smart appliances, smart windows or doors, smart garage doors, smart lights, smart piping, smart toilets, smart sump pumps, smart refrigerators, and/or smart washers. The faulty device may be a faulty water hose, valve, or piping, and the trend detected may be associated with an increase in claims having water leakage as a cause of loss.

In another aspect, a computer system configured to detect emerging trends in claims and/or other data is provided. The computer system may include one or more processors, servers, and/or transceivers configured to: (1) receive new insurance claims, the new insurance claims including data in several data fields; (2) input the new insurance claims into a machine learning model trained to identify or detect trends in one or more of the several data fields; (3) identify or detect, via the machine learning model, an emerging trend in one of the several data fields or otherwise embedded in the new insurance claims; and/or (4) determine one or more corrective actions to mitigate or preventive actions to limit damage to insured assets caused by the emerging trend. The system may include additional, less, or alternative functionality, including that discussed elsewhere herein.

For instance, the one or more corrective actions or preventive actions include generating, via one or more processors, an electronic warning report that indicates the emerging trend in one of the several data fields (or otherwise in the new insurance claims). The one or more corrective actions or preventive actions may include identifying, via one or more processors, a faulty device causing the emerging trend.

The new insurance claims may relate to, or be associated with, auto insurance claims, and the faulty device may be associated with an autonomous vehicle feature or system employed by an autonomous or semi-autonomous vehicle, such as a sensor, electronic component, or software version.

The new insurance claims may relate to, or be associated with, homeowners insurance claims, and the faulty device may be associated with a smart or intelligent home feature or system, such as a sensor, electronic component, or software version.

In the example embodiment, the one or more processors are further configured to: identify a faulty device causing the emerging trend; identify an customer having a device, appliance, vehicle, or home having the faulty device; generate an electronic notification detailing the faulty device and/or recommended actions (such as repair or replacement) to alleviate risk associated with the faulty device; and/or transmit the electronic notification to a mobile device associated with the customer.

In the example embodiment, the one or more processors are further configured to identify a faulty device causing the emerging trend and the new insurance claims comprise auto insurance claim. Identifying a faulty device causing the emerging trend includes the one or more processors: collecting vehicle data generated by one or more vehicles; and/or verifying that the faulty device causing the emerging trend identified, or otherwise is need of repair or replacement, based upon processor analysis of the vehicle data collected.

The faulty device may be verified using the vehicle data prior to one or more corrective actions being determined. The one or more corrective actions may include repairing or replacing the faulty device.

In another embodiment, the new insurance claims comprise homeowners insurance claims, and identifying a faulty device causing the emerging trend includes the one or more processors: collecting home data generated by one or more homes; and/or verifying that the faulty device causing the emerging trend identified, or otherwise is need of repair or replacement, based upon processor analysis of the home data collected. The faulty device may be verified using the home data prior to one or more corrective actions being determined, the one or more corrective actions including repairing or replacing the faulty device.

In some embodiments, the machine learning model is trained to identify or detect emerging trends in insurance claims, at least in part, by building a baseline for each of the several data fields, and an emerging trend is identified when one of the data fields deviates from the respective baseline by a predetermined threshold. The threshold may be a percentage or an amount deviated from the baseline.

In the example embodiment, the machine learning model is trained to identify or detect emerging trends in insurance claims (or data in one or more of the several data fields) by inputting historical insurance claims (including data in one or more of the several data fields) into the machine learning model. The new insurance claims and/or the historical insurance claims may relate to auto, homeowners, personal articles, life, health, disability, or workers compensation insurance claims. Additionally or alternatively, the new insurance claims and/or the historical insurance claims may include several data fields related to claim severity; claim frequency; peril or cause of loss; coverage; coverage amount; line of business (such as auto or homeowners insurance); and/or state, city, or geographical area. Additionally or alternatively, the new insurance claims and/or the historical insurance claims may include several data fields related to one or more types of expense information, including claims expenses, litigation expenses, acquisition expenses, salaries, underwriting expenses, travel expenses, and/or equipment expenses.

The emerging trend in the new insurance claims or in one of the data fields identified is further used, by one or more processors, to predict future claims and/or causes of loss. The new insurance claims may relate to auto insurance, and the trend detected or identified may be an increase in auto claims severity or frequency due to a faulty vehicle component. The faulty vehicle component may include one or more blown tires, safety recall components, steering wheels, and/or other vehicle components. Additionally or alternatively, the faulty vehicle component may include one or more sensors, software or software versions, and/or electronic components related to autonomous vehicle features, systems, or technologies.

The new insurance claims may relate to auto insurance, and the emerging trend detected or identified may be an increase in auto claims severity or frequency due to a particular peril or cause of loss, wherein the cause of loss is water damage or water-related.

In another embodiment, the new insurance claims may relate to homeowners insurance, and the emerging trend detected or identified may be an increase in homeowners insurance claims severity or frequency due to a faulty device. For instance, the faulty device may include one or more sensors, software or software versions, and/or electronic components related to intelligent home or smart home features, systems, or technologies, including security alarms, smart appliances, smart windows or doors, smart garage doors, smart lights, smart piping, smart toilets, smart sump pumps, smart refrigerators, and/or smart washers. Additionally or alternatively, the faulty device may be a faulty water hose, valve, and/or piping, and the trend detected may be associated with an increase in claims having water leakage as a cause of loss.

### Exemplary Unsupervised Machine Learning Techniques

The unsupervised machine learning techniques, modules, programs, and algorithms discussed herein may identify hidden structure and/or emerging trends in unlabeled claim data. The unsupervised machine learning techniques may include clustering techniques, cluster analysis, anomaly detection techniques, multivariate data analysis, probability techniques, unsupervised quantum learning techniques, associate mining or associate rule mining techniques, and/or the use of neural networks. In some embodiments, semi-supervised learning techniques may be employed.

In some embodiments, the machine learning techniques described in Quantum Algorithms for Supervised and Unsupervised Machine Learning, by Seth Lloyd et al.; A Comparative Evaluation of Unsupervised Anomaly detection Algorithms for Multivariate Data, by Markus Goldstein, et al.; and Unsupervised Machine Learning, by R. Gentleman et al., which are hereby incorporated herein by reference in their entireties, may be employed.

In one aspect, a computer-implemented method of detecting emerging trends in insurance claims using unsupervised machine learning techniques is provided. The method may include (1) receiving, via one or more processors and/or associated transceivers, new insurance claims, the new insurance claims including claim data in several data fields, and may be organized by line of business by state; (2) inputting, via one or more processors, the new insurance claims into a unsupervised machine learning model (such as an trend detection server having an unsupervised machine learning model) to identify or detect (i) one or more emerging trends in one or more of the several data fields, or otherwise in the new insurance claims; (3) collecting or receiving, via one or more processors and/or associated transceivers, noninsurance data to verify the emerging trends in the new insurance claims, or the data fields; (4) analyzing, via one or more processors, the new insurance claims and/or the noninsurance data to determine a root cause of the emerging trend; and/or (5) determining, via one or more processors, a corrective action to mitigate or a preventive action to limit future damage to insured or insurable assets caused by the root cause of the merging trend. The method may include additional, less, or alternative actions, including those discussed elsewhere herein.

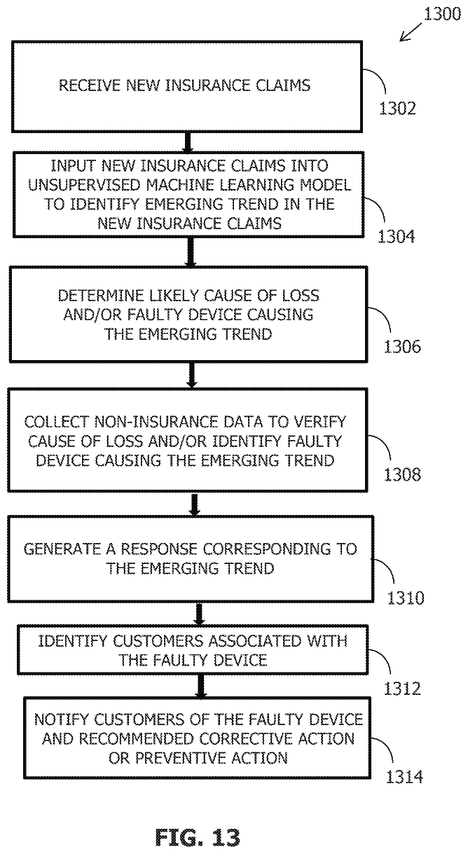

FIG. 13 depicts another exemplary computer-implemented method of detecting emerging trends in claims data 1300. In the example embodiment, the method 1300 includes receiving new insurance claims being filed/submitted 1302. The new insurance claims may be received or organized by line of business and/or by state, in some embodiments.

In the example embodiment, the method 1300 includes inputting the new insurance claims into an unsupervised machine learning model that is configured to identify emerging trends in insurance claims 1304. Emerging trends may relate to, inter alia, (i) new auto insurance claims of new make or models of automobiles, (ii) new auto insurance claims for automobiles having specific types of autonomous or semi-autonomous systems or features, (iii) new auto insurance claims for autonomous vehicles having the same type of autonomous or semi-autonomous features, systems, or software, (iv) new auto insurance claims for vehicles having the same type of components, such as the same type clutch, transmission, steering wheels, entertainment systems, tires, drive trains, brakes, or power steering, (v) new homeowners insurance claims for houses with the same type of roofing, shingles, windows, doors, siding, lighting, cabinets, tiles, plumping, piping, toilets, appliances, smart appliances, smart doors, smart lighting, smart toilets, smart pluming or piping, or smart sprinkler systems, and/or (vi) new homeowners insurance claims for houses equipment for intelligent or smart functionality, systems, and features, which may include various smart sensors and software interacting with a smart home controller.

The emerging trends detected or identified may relate to cause of loss or peril, reported claims, claim severity, claim frequency, line of business (e.g., auto, home, life, or health), geographical area (such as state or city), damage, loss, injury, and/or other conditions associated with an insurance claim or insured asset. The emerging trends detected or identified may also relate to different expenses, such as claim expenses, litigation expenses, acquisition expenses, salaries, and underwriting expenses, travel expense and equipment expenses.

In the example embodiment, if an emerging trend is identified by the machine learning model, such as increase in claim frequency or severity in auto or homeowners insurance claims in Texas, further analysis of the claim data is performed. For instance, once an emerging trend is identified, the method 1300 includes analyzing, via one or more processors of a machine learning model, the insurance claims to determine or predict a likely cause of loss for the new insurance claims, or determine or identify a likely faulty device causing the emerging trend in new insurance claims 1306.

For instance, if the same make and model of an autonomous vehicle is experiencing an uptick in claims, the root cause of the claims may be that one of the autonomous vehicle systems was currently upgraded to include a new device, component, or software version that is faulty or malfunctioning. If the homes in a given state are experiencing an uptick in claims, the root cause of the claims may be faulty manufacturing or construction materials used throughout a state or region. If smart homes with the same smart home functionality are experiencing an uptick in a given type of claims, the root cause may be associated with malfunctioning smart home sensors, components, or software, e.g., smart home security systems for theft claims or smart fire suppression systems for fire claims.

In one embodiment, the claim data of the insurance claims comprise several data fields, such as two- or three-digit numbers, or alphanumeric codes. One or more of the data fields may each be associated with a predetermined likely cause or causes of loss, which may be organized in a table. If an emerging trend is detected in the insurance claims, one or more processors identify which data fields are prevalent or otherwise are above normal or deviate from a baseline within the new insurance claims. Those outlier or abnormal data fields are used to access the table of causes of loss, and retrieve the corresponding likely cause or causes of loss, such as a faulty sump pump or leaking piping for flood or water damage in a basement.

In the example embodiment, once a likely cause of loss is identified, the method 1300 includes gathering or collecting noninsurance data from customers associated with the new insurance claims, and/or other customers 1308. The noninsurance data are used to verify the cause of loss and/or identify a faulty device. For instance, processor analysis of the data gathered from an autonomous vehicle may reveal that one or more components or sensors are not operating or sending control signals as intended, or that the one or more software versions controlling autonomous vehicle features is corrupted or has a bug or flaw. Other causes of loss, such as for homes or vehicles, may include water, wind, storm surge, fire, smoke, faulty components, hail, collision, and/or other causes of loss, including those discussed elsewhere herein.

In the example embodiment, the method 1300 includes generate a response corresponding to the emerging trend. The response comprises determining corrective actions to mitigate or preventive actions to limit damage to insured assets cause by the faulty device identified 1310. The one or more corrective actions may include generating, via one or more processors, an electronic warning report that indicates the trend in the new insurance claims and/or one of the several data fields and/or recommended repairs or replacement. The one or more corrective actions may also include identifying, via one or more processors, a faulty device or component causing the emerging trend.

In some embodiments, the new insurance claims may relate to, or be associated with, auto insurance claims, and the faulty device may be associated with an autonomous vehicle feature or system employed by an autonomous or semi-autonomous vehicle, such as a sensor, electronic component, or software version. In some embodiments, the new insurance claims may relate to, or be associated with, homeowners insurance claims, and the faulty device may be associated with a smart or intelligent home feature or system, such as a sensor, electronic component, or software version.

For instance, if a vehicle feature has a faulty component or sensor, replacement parts may be ordered, via one or more processors, and maintenance with a repair facility may be automatically scheduled, via the one or more processors. Or if an autonomous vehicle feature has a corrupted or outdated software version, the one or more processors, may automatically replace the faulty software version with an updated software version with the vehicle owner's permission.

The method 1300 may include identifying customers associated with, or having the faulty device 1312. The method 1300 may include notifying the customers of the faulty device, and recommendations to mitigate the corresponding elevated risk of damage to insured assets 1314. For instance, one or more processors may generate an electronic notification and transmit it to mobile devices of impacted customers.

The method may include identifying, via one or more processors, a faulty component causing the emerging trend and the new insurance claims comprise auto insurance claims. Identifying, via one or more processors, a faulty device causing the emerging trend may include: collecting, via one or more processors, vehicle data generated by or associated with one or more vehicles; and/or verifying, via one or more processors, that the faulty device causes the emerging trend identified, trend, or otherwise is need of repair or replacement, based upon processor analysis of the vehicle data collected. The faulty device may be verified using the vehicle data prior to one or more corrective actions are determined, the one or more corrective actions including repairing or replacing the faulty device.

The method may include identifying, via one or more processors, a faulty device causing the emerging trend, and the new insurance claims may comprise homeowners insurance claims. Identifying, via one or more processors, a faulty device causing the emerging trend may include collecting, via one or more processors, home data generated by or associated with one or more homes; and/or verifying, via one or more processors, that the faulty device causing the emerging trend identified using the new insurance claims is the cause of the emerging trend, or otherwise is need of repair or replacement, based upon processor analysis of the home data collected. The faulty device may be verified using the home data prior to one or more corrective actions being determined, the one or more corrective actions including repairing or replacing the faulty device.

In another aspect, a computer system configured to detect emerging trends in insurance claims is provided. The system may include one or more processors, servers, sensors, and/or transceivers configured to: (1) receive or retrieve new insurance claims, the new insurance claims including claim data in several data fields, and may be organized by line of business; (2) input the new insurance claims into a unsupervised machine learning model to identify or detect one or more emerging trends in the new insurance claims or in one or more of the several data fields; and/or (3) collect, retrieve, or receive noninsurance data to verify the one or more emerging trends in the new insurance claims. The system may include additional, less, or alternative functionality, including that discussed elsewhere herein.

The one or more processors may be further configured to generate a response corresponding to the emerging trend. A response may include determining one or more corrective actions to mitigate or preventive actions to limit damage to insured assets caused by the emerging trend, or the root cause thereof. The one or more processors may be further configured to generate an electronic warning report that indicates the trend in one of the several data fields, and/or in the new insurance claims. The one or more processors are further configured to identify a faulty device or component causing the emerging trend.

In another aspect, a computer-implemented method for detecting or identifying emerging trends in insurance claims is provided, where the claim data of an insurance claim dynamically evolve (e.g., the example insurance claim shown in FIG. 8). The method may include (1) accessing, retrieving, or receiving, via one or more processors and/or associated transceivers, claim data associated with new insurance claims, where the new insurance claims may be organized by or associated with one line of business by state, the claim data of new insurance claims having one or more data fields; (2) inputting, via one or more processors, the claim data into an unsupervised machine learning model to identify or detect one or more emerging trend in the claim data, and/or one or more data fields of the claim data; (3) receiving, accessing, or retrieving, via one or more processors and/or associated transceivers, noninsurance data; and/or (4) verifying or confirming, via one or more processors, the one or more emerging trends in the claim data of the new insurance claims, and/or one or more data fields of the claim data of new insurance claims using, or based upon, processor analysis of the noninsurance data. The method may include additional, less, or alternative actions, including those discussed elsewhere herein.

For instance, the method may include determining, via one or more processors, a root cause of the emerging trend in the new insurance claims based upon processor analysis of the new insurance claims and/or noninsurance data. The method may include generating a response corresponding to the emerging trend. A response may include identifying, via one or more processors, one or more corrective actions to mitigate or preventive actions to limit future damage to insured assets caused by the root cause of the emerging trend in the new insurance claims.

In another aspect, a computer system configured to detect or identify emerging trends in insurance claims is provided, where the claim data of an insurance claim dynamically evolve (e.g., the example insurance claim shown in FIG. 8). The system may include one or more processors, servers, sensors, and/or transceivers configured to: (1) access, retrieve, or receive claim data associated with new insurance claims, the claim data of the new insurance claims being organized by or associated with one line of business by state, the claim data of the new insurance claims having one or more data fields; (2) input the dynamic claim data set into an unsupervised machine learning model to identify or detect one or more emerging trend in the claim data of the new insurance claims, and/or one or more data fields of the claim data of the new insurance claims; (3) receive, access, or retrieve noninsurance data; and/or (4) verify or confirm the emerging trends in the new insurance claims, and/or one or more data fields of the new insurance claims using, or based upon, processor analysis of the noninsurance data. The system may include additional, less, or alternative functionality, including that discussed elsewhere herein.

### Exemplary Trend Detection System

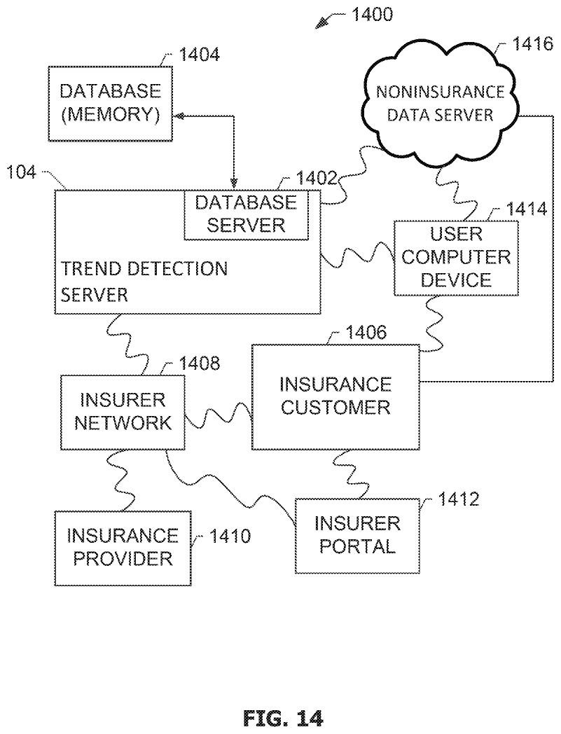

FIG. 14 illustrates an exemplary block diagram of a trend detection system 1400. In the exemplary embodiment, trend detection system includes at least a trend detection server 104. Trend detection server 104 may include a database server 1402 in communication with a database 1404. In some embodiments, database 1404 comprises historical insurance claims. Database 1404 may further comprise noninsurance data.

In the exemplary embodiment, trend detection server 104 is in communication with the noninsurance data server 1416. Noninsurance data server 1416 may also be in communication with user computer device 1414. Trend detection server 104 may communicate with insurance customer 1406 via user computer device 1414. Trend detection server 104 is communicatively coupled to insurer network 1408. In some embodiments, insurance provider 1410 may be in direct communication with trend detection server 1408.

Insurance customer 1406 may alternatively communicate with trend detection server and/or insurance provider 1410 using an insurer portal 1412 via insurer network 1408. In the exemplary embodiment, insurer portal 1412 is communicatively coupled to insurer network 1408. In some embodiments, insurer portal 1412 is an electronic platform for a customer to apply for insurances and interact with an insurer.

### Exemplary User Computer Device

FIG. 15 illustrates an exemplary configuration 1500 of an exemplary user computer device 1502. In some embodiments, user computer device 1502 may be client device 202 (shown in FIG. 2) or user computer device 1414 (shown in FIG. 14).

User computer device 1502 may be operated by a user 1504 (e.g., an insurance customer). User computer device 1502 may receive input from user 1504 via an input module 1506. User computer device 1502 includes a processor 1508 for executing instructions. In some embodiments, executable instructions may be stored in a memory area 1510. Processor 1508 may include one or more processing units (e.g., in a multi-core configuration). Memory area 1510 may be any device allowing information such as executable instructions and/or transaction data to be stored and retrieved. Memory area 1510 may include one or more computer-readable media.

User computer device 1502 may also include at least one media output component 1512 for presenting information to user 1504. Media output component 1512 may be any component capable of conveying information to user 1504. In some embodiments, media output component 1512 may include an output adapter (not shown), such as a video adapter and/or an audio adapter. An output adapter may be operatively coupled to processor 1508 and operatively coupleable to an output device, such as a display device (e.g., a cathode ray tube (CRT), liquid crystal display (LCD), light emitting diode (LED) display, or “electronic ink” display) or an audio output device (e.g., a speaker or headphones). In some embodiments, media output component 1512 may be configured to present a graphical user interface (e.g., a web browser and/or a client application) to user 1504.

In some embodiments, user computer device 1502 may include an input device for receiving input from user 1504. User 1504 may use input devices to, without limitation, interact with trend detection server 104 (shown in FIG. 1), noninsurance data server 1416 (shown in FIG. 14), or insurer portal 1412 (shown in FIG. 14). Input devices may include, for example, a keyboard, a pointing device, a mouse, a stylus, and/or a touch sensitive panel (e.g., a touch pad or a touch screen). A single component, such as a touch screen, may function as both an output device of media output component 1512 and an input device. User computer device 1504 may further include at least one sensor, including, for example, a gyroscope, an accelerometer, a position detector, a biometric input device, a telematics data collection device, and/or an audio input device. In some embodiments, at least some data collected by user computer device 1504 may be transmitted to insurance provider 1410 to, for example, generate models. In the exemplary embodiment, data collected by user computer device 1502 may be included in a claim submission. In some embodiments, data collected by user computer device 1502 is distributed to a noninsurance data server to be stored in a database.

User computer device 1502 may also include a communication interface 1514, communicatively coupled to insurance provider 1410 (shown in FIG. 14) or insurer network 1408 (shown in FIG. 14). Communication interface 1514 may include, for example, a wired or wireless network adapter and/or a wireless data transceiver for use with a mobile telecommunications network.

Stored in memory area 1510 may be, for example, computer-readable instructions for providing a user interface to user 1504 via media output component 1512 and, optionally, receiving and processing input from an input device using input module 1506. The user interface may include, among other possibilities, a web browser and/or a client application. Web browsers enable users, such as user 1504, to display and interact with media and other information typically embedded on a web page or a website hosted by insurance provider 1410 and/or accessible by user computer device 1502. A client application may allow user 1504 to interact with, for example, trend detection server 104 (shown in FIG. 1), noninsurance data server 1416 (shown in FIG. 14), and insurer portal 1412 (shown in FIG. 4). For example, instructions may be stored by a cloud service and the output of the execution of the instructions may be sent to the media output component 1512.

### Exemplary Server Device

FIG. 16 depicts an exemplary configuration 1600 of an exemplary server computer device 1601, in accordance with one embodiment of the present disclosure. Server computing device 1601 may include, but is not limited to, trend detection server 104 (shown in FIG. 1), the server device 204 (shown in FIG. 2), the database server 1402 and noninsurance data server 1416 (shown in FIG. 14). Server computer device 1601 may include a processor 1605 for executing instructions. Instructions may be stored in a memory area 1610. Processor 1605 may include one or more processing units (e.g., in a multi-core configuration).

Processor 1605 may be operatively coupled to a communication interface 1615 such that server computer device 1601 may be capable of communicating with a remote device such as another server computer device 1601 or user computer device 1414 (shown in FIG. 14). For example, communication interface 1615 may receive requests from or transmit requests to user computer device 1502 (shown in FIG. 14) via the Internet.

Processor 1605 may also be operatively coupled to a storage device 1620. Storage device 1620 may be any computer-operated hardware suitable for storing and/or retrieving data, such as, but not limited to, historical insurance claims, new insurance claims, and noninsurance data. In some embodiments, storage device 1620 may be integrated in server computer device 1601. For example, server computer device 1601 may include one or more hard disk drives as storage device 1620. In other embodiments, storage device 1620 may be external to server computer device 1601 and may be accessed by a plurality of server computer devices 1601. For example, storage device 1620 may include a storage area network (SAN), a network attached storage (NAS) system, and/or multiple storage units such as hard disks and/or solid state disks in a redundant array of inexpensive disks (RAID) configuration.

In some embodiments, processor 1605 may be operatively coupled to storage device 1620 via a storage interface 1625. Storage interface 1625 may be any component capable of providing processor 1605 with access to storage device 1620. Storage interface 1625 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 1605 with access to storage device 1620.

Processor 1605 executes computer-executable instructions for implementing aspects of the disclosure. In some embodiments, processor 1605 may be transformed into a special purpose microprocessor by executing computer-executable instructions or by otherwise being programmed. For example, processor 1605 may be programmed with the instructions as illustrated in FIGS. 10-13.

### Exemplary Embodiments & Functionality

In one aspect, a computer system for detecting an emerging trend in insurance claims may be provided. The computer system may include at least one processor in communication with at least one memory device. Each insurance claim may comprise a customer profile of a customer and claim data associated with the customer. The at least one processor may be programmed to: (1) receive, from a database, a plurality of historical insurance claims; (2) store a machine learning model based upon the plurality of historical insurance claims; (3) input a plurality of new insurance claims into the machine learning model; (4) compare the plurality of new insurance claims with the machine learning model; (5) identify, by the machine learning model, the emerging trend in the new insurance claims; and/or (6) generate a response corresponding to the emerging trend.

A further enhancement may be where the computer system may generate the machine learning model based upon the plurality of historical insurance claims by training the machine learning model with the plurality of historical insurance claims.

A further enhancement may be where the claim data of each insurance claim may comprise at least one data field, and the computer system may train the machine learning model to detect the emerging trend in the insurance claims by building a baseline for each of at least one data field and identifying the emerging trend when one of the at least one data field deviates from the respective baseline by a predetermined threshold.

In one embodiment, the machine learning model may be a supervised machine learning model. In another embodiment, the machine learning model may be an unsupervised machine learning model. In yet another embodiment, the machine learning model may be or include both an unsupervised machine learning model and a supervised machine learning model. In other words, the machine learning model may be a combination of both a supervised machine learning model and an unsupervised machine learning model.

A further enhancement may be where the computer system may update the machine learning model with the new insurance claims.

A further enhancement may be where the response may include at least one of determining corrective actions that mitigate damage caused by the emerging trend, determining preventive actions that limit damage caused by the emerging trend in a future period of time and adjusting an insurance policy based upon the emerging trend.

A further enhancement may be where the response may include identifying a faulty device that causes the emerging trend.

A further enhancement may be where the insurance claims may comprise auto insurance claims, and the faulty device is associated with an autonomous vehicle system.

A further enhancement may be where the insurance claims may comprise homeowners insurance claims, and the faulty device is associated with at least one of a smart home system and a smart appliance.

A further enhancement may be where the response may include generating an electronic warning report indicating the emerging trend.

A further enhancement may be where the computer system may identify a faulty device causing the emerging trend; identify a customer having the faulty device; generate an electronic warning report describing the faulty device; and/or transmit the electronic warning report to the identified customer.

A further enhancement may be where the insurance claims may comprise auto insurance claims, and the computer system may identify a faulty device causing the emerging trend; collect vehicle data associated with one or more vehicles; and/or verify that the faulty device is a cause of the emerging trend, based upon analysis of the collected vehicle data.

A further enhancement may be where the insurance claims may comprise homeowners insurance claims, and the computer system may identify a faulty device causing the emerging trend; collect home data associated by one or more homes; and/or verify that the faulty device is a cause of the emerging trend based upon analysis of the collected home data.

A further enhancement may be where the computer system may receive noninsurance data associated with customers of the insurance claims; and/or verify the emerging trend using the noninsurance data.

In another aspect, a computer system for detecting an emerging trend in insurance claims may be provided. The computer system may include at least one processor in communication with at least one memory device. Each insurance claim may comprise a customer profile of a customer and claim data associated with the customer. The at least one processor may be programmed to (1) store a machine learning model; (2) input a plurality of new insurance claims into the machine learning model; (3) identify, by the machine learning model, the emerging trend in the new insurance claims; and/or (4) generate a response corresponding to the emerging trend.

A further enhancement may be where the claim data of each insurance claim may comprise at least one data field, and the computer system may train the machine learning model to detect the emerging trend in insurance claims by constructing a baseline for each of at least one data field and identifying the emerging trend when one of the at least one data field deviates from the respective baseline by a predetermined threshold.

A further enhancement may be where the computer system may identify a faulty device causing the emerging trend; identify a customer having the faulty device; generate an electronic warning report describing the faulty device; and/or transmit the electronic warning report to the identified customer.

In at least one further aspect, a computer-implemented method for detecting an emerging trend in insurance claims may be provided. Each insurance claim may comprise a customer profile of a customer and claim data associated with the customer. The method may be implemented on a trend detection server including at least one processor in communication with at least one memory device. The method may include: (1) storing a machine learning model; (2) inputting a plurality of new insurance claims into the machine learning model; (3) identifying, by the machine learning model, the emerging trend in the new insurance claims; and/or (4) generating a response corresponding to the emerging trend.

A further enhancement to the method may include where the insurance claims may comprise homeowners insurance claims, and the method may include identifying a faulty device causing the emerging trend; collecting home data associated with one or more homes; and/or verifying that the faulty device is a cause of the emerging trend based upon analysis of the collected home data.

A further enhancement to the method may include where the insurance claims may include auto insurance claims, and the method may further include identifying a faulty device causing the emerging trend; collecting vehicle data associated with one or more vehicles; and/or verifying that the faulty device is a cause of the emerging trend, based upon analysis of the collected vehicle data.

A further enhancement to the method may include where the method may include receiving, from a database, a plurality of historical insurance claims; and/or training the machine learning model with the historical insurance claims.

### Technical Advantages

The aspects described herein may be implemented as part of one or more computer components such as a client device and/or one or more back-end components, such as a customer assessment engine, for example. Furthermore, the aspects described herein may be implemented as part of a computer network architecture and/or a cognitive computing architecture that facilitates communications between various other devices and/or components. Thus, the aspects described herein address and solve issues of a technical nature that are necessarily rooted in computer technology.

For instance, aspects include analyzing various sources of data to identifying potential or actual emerging trends or anomalies in claim data that may otherwise go unnoticed for some time. In doing so, the aspects overcome issues associated with the inconvenience of manual and/or unnecessary monitoring of claim data by replacing manual procedures with a cognitive-based computing system. Without the improvements suggested herein, additional processing and memory usage would be required to perform such monitoring. Additional technical advantages include, but are not limited to: i) improved speed and responsiveness in responding to the market; ii) real-time analysis of trends; iii) improved response time to emerging trends; and iv) reduced lag between the start of a trend and the identification of said trend. Additional technical advantages are described in other sections of the specification.

Furthermore, the embodiments described herein improve upon existing technologies, and improve the functionality of computers, by more accurately predict or identify emerging trends, and identify and verify the root causes thereof. The present embodiments improve the speed, efficiency, and accuracy in which such calculations and processor analysis may be performed. Due to these improvements, the aspects address computer-related issues regarding efficiency over conventional techniques. Thus, the aspects also address computer related issues that are related to efficiency metrics, for example.

### Additional Considerations

With the foregoing, any users (e.g., insurance customers) whose data is being collected and/or utilized may first opt-in to a reward, insurance discount, or other type of program. After the user provides their affirmative consent or permission, data may be collected from the user's devices (e.g., mobile device, smart or autonomous vehicle controller, smart home controller, or other smart devices). In return, the user may be entitled insurance cost savings, including insurance discounts for auto, homeowners, mobile, renters, personal articles, life, health, and/or other types of insurance.

In the above description, neural networks may also refer to other methods of artificial intelligence and machine learning. In other embodiments, deployment and use of neural network models at a user device may have the benefit of removing any concerns of privacy or anonymity, by removing the need to send any personal or private data to a remote server.

The following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium) or hardware. In hardware, the routines are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory product to which it is communicatively coupled. A further hardware module may then, at a later time, access the memory product to retrieve and process the stored output. Hardware modules may also initiate communications with input or output products, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a building environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a building environment, an office environment, or a server farm). In other example embodiments, the one or more processors or processor-implemented modules may be distributed across a number of geographic locations.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Upon reading this disclosure, those of skill in the art will appreciate still additional alternative structural and functional designs for a system and a process of performing the methods and systems disclosed herein, using the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A computer system for detecting an emerging trend in insurance claims, the computer system including at least one processor in communication with at least one memory device, each insurance claim comprising a customer profile of a customer and claim data associated with the customer, the at least one processor is programmed to:
receive, from a database, a plurality of historical insurance claims;
store a neural network model based upon the plurality of historical insurance claims, wherein the neural network model includes an input layer including a plurality of input neurons, a plurality of hidden layers each including at least one neuron, and an output layer including a plurality of output neurons;
input a plurality of new insurance claims into the neural network model, wherein each new insurance claim of the plurality of new insurance claims is loaded into the plurality of input neurons of the input layer;
analyze the plurality of new insurance claims via the plurality of hidden layers of the neural network model;
receive one or more outputs from the neural network model;
identify the emerging trend in the new insurance claims based on the one or more outputs from the neural network model; and
generate a response corresponding to the emerging trend.

2. The computer system of claim 1, wherein the at least one processor is further programmed to:
generate the neural network model based upon the plurality of historical insurance claims by training the neural network model with the plurality of historical insurance claims.

3. The computer system of claim 1, wherein the claim data of each insurance claim comprises at least one data field, and the at least one processor is further programmed to:
train the neural network model to detect the emerging trend in the insurance claims by building a baseline for each of at least one data field and identifying the emerging trend when one of the at least one data field deviates from the respective baseline by a predetermined threshold.

4. The computer system of claim 1, wherein the at least one processor is further programmed to:
update the neural network model with the new insurance claims.

5. The computer system of claim 1, wherein the response includes at least one of determining corrective actions that mitigate damage caused by the emerging trend, determining preventive actions that limit damage caused by the emerging trend in a future period of time, and adjusting an insurance policy based upon the emerging trend.

6. The computer system of claim 1, wherein the response includes identifying a faulty device that causes the emerging trend and notifying at least one of a manufacturer of the faulty device and a customer having the faulty device about the faulty device.

7. The computer system of claim 6, wherein the insurance claims comprise auto insurance claims, and the faulty device is associated with an autonomous vehicle system.

8. The computer system of claim 6, wherein the insurance claims comprise homeowners insurance claims, and the faulty device is associated with at least one of a smart home system and a smart appliance.

9. The computer system of claim 1, wherein the at least one processor is further programmed to:
receive noninsurance data;
input the noninsurance data into the neural network model; and
train the neural network model with the noninsurance data.

10. The computer system of claim 1, wherein the at least one processor is further programmed to:
identify a faulty device causing the emerging trend;
identify a customer having the faulty device;
generate an electronic warning report describing the faulty device; and
transmit the electronic warning report to the identified customer.

11. The computer system of claim 1, wherein the insurance claims comprise auto insurance claims, and the at least one processor is further programmed to:
identify a faulty device causing the emerging trend;
collect vehicle data associated with one or more vehicles;
verify that the faulty device is a cause of the emerging trend, based upon analysis of the collected vehicle data; and
notify at least one of a manufacturer of the faulty device and a customer having the faulty device about the faulty device.

12. The computer system of claim 1, wherein the insurance claims comprise homeowners insurance claims, and the at least one processor is further programmed to:
identify a faulty device causing the emerging trend;
collect home data associated by one or more homes; and
verify that the faulty device is a cause of the emerging trend based upon analysis of the collected home data.

13. The computer system of claim 1, wherein the at least one processor is further configured to:
receive noninsurance data associated with customers of the insurance claims; and
verify the emerging trend using the noninsurance data.

14. A computer system for detecting an emerging trend in insurance claims, the computer system including at least one processor in communication with at least one memory device, each insurance claim comprising a customer profile of a customer and claim data associated with the customer, the at least one processor is programmed to:
store a neural network model including an input layer including a plurality of input neurons, a plurality of hidden layers each including at least one neuron, and an output layer including a plurality of output neurons;
input a plurality of new insurance claims into the neural network model, wherein each new insurance claim of the plurality of new insurance claims is loaded into the plurality of input neurons of the input layer;
analyze the plurality of new insurance claims via the plurality of hidden layers of the neural network model;
receive one or more outputs from the neural network model;
identify the emerging trend in the new insurance claims based on the one or more outputs from the neural network model; and
generate a response corresponding to the emerging trend.

15. The computer system of claim 14, wherein the claim data of each insurance claim comprises at least one data field, and the at least one processor is further programmed to:
train the neural network model to detect the emerging trend in insurance claims by constructing a baseline for each of at least one data field and identifying the emerging trend when one of the at least one data field deviates from the respective baseline by a predetermined threshold.

16. The computer system of claim 14, wherein the at least one processor is further programmed to:
identify a faulty device causing the emerging trend;
identify a customer having the faulty device;
generate an electronic warning report describing the faulty device; and
transmit the electronic warning report to the identified customer.

17. The computer system of claim 1, wherein the neural network model is a combination of both a supervised machine learning model and an unsupervised machine learning model.

18. A computer-implemented method for detecting an emerging trend in insurance claims, each insurance claim comprising a customer profile of a customer and claim data associated with the customer, the method implemented on a trend detection server including at least one processor in communication with at least one memory device, the method comprising:
storing a neural network including an input layer including a plurality of input neurons, a plurality of hidden layers each including at least one neuron, and an output layer including a plurality of output neurons;
inputting a plurality of new insurance claims into the neural network model, wherein each new insurance claim of the plurality of new insurance claims is loaded into the plurality of input neurons of the input layer;
analyzing the plurality of new insurance claims via the plurality of hidden layers of the neural network model;
receiving one or more outputs from the neural network model;
identifying the emerging trend in the new insurance claims based on the one or more outputs from the neural network model; and
generating a response corresponding to the emerging trend.

19. The method of claim 18, wherein the insurance claims comprise auto insurance claims, the method further comprising:
receiving noninsurance data;
identifying a faulty device causing the emerging trend;
verifying that the faulty device is a cause of the emerging trend, based upon analysis of the noninsurance data; and
notifying at least one of a manufacturer of the faulty device and a customer having the faulty device about the faulty device.

20. The method of claim 18, further comprising:
receiving, from a database, a plurality of historical insurance claims;
inputting the plurality of historical insurance claims into the neural network model; and
training the neural network model with the historical insurance claims.

21. The method of claim 18, further comprising:
receiving noninsurance data;
inputting the noninsurance data into the neural network model; and
training the neural network model with the noninsurance data.
